(19) United States
(12) Patent Application Publication
(10) Pub. No.: US 2024/0173957 A1
(43) Pub. Date: May 30, 2024

(54) LAMINATED SHEET PROCESSING METHOD AND LAMINATED SHEET PROCESSING DEVICE

(71) Applicant: NITTO DENKO CORPORATION, Ibaraki-shi, Osaka (JP)

(72) Inventors: Akiyoshi Yamamoto, Osaka (JP); Yosuke Yamada, Osaka (JP); Takayuki Nomura, Osaka (JP); Hiromichi Kosaka, Osaka (JP)

(73) Assignee: NITTO DENKO CORPORATION, Ibaraki-shi, Osaka (JP)

(21) Appl. No.: 18/284,156

(22) PCT Filed: Mar. 23, 2022
(86) PCT No.: PCT/JP2022/013730

§ 371 Date: Sep. 26, 2023

(30) Foreign Application Priority Data
Mar. 30, 2021 (JP) 2021-056377

(51) Int. Cl. B32B 43/00; C08J 11/08; C11D 7/06; C11D 7/50

(52) U.S. Cl. CPC B32B 43/006; C08J 11/08; C11D 7/06; C11D 7/5022; C08J 2321/00; C08J 2333/04; C08J 2379/08; C08J 2383/04

(57) ABSTRACT

Provided is a laminated sheet processing method capable of easily separating a base material for forming many kinds of laminated sheets, such as pressure-sensitive adhesive tapes, release films, and antistatic films, and a functional layer such as a pressure-sensitive adhesive layer, a release layer, and an antistatic layer laminated on the base material, from each other, at low cost. Furthermore, a laminated sheet processing device used for such a laminated sheet processing method is provided. The laminated sheet processing method according to an embodiment of the present invention is a method for processing a laminated sheet including a base material layer and a functional layer, and includes a step (I) of applying a separation liquid to a surface of the functional layer.

### TECHNICAL FIELD

The present invention relates to a laminated sheet processing method and a laminated sheet processing device.

### BACKGROUND ART

Laminated sheets such as pressure-sensitive adhesive tapes, release films, and antistatic films have been used in a large amount in, for example, bonding of labels or the like to articles or wrapping materials, packaging of packaging materials, production processes for electronic members or optical members, and masking application. In particular, in recent years, the frequency at which the laminated sheets are used in the production processes for the electronic members or the optical members has been increasing, and hence a large amount of laminated sheet waste has been produced in, for example, production sites.

Typically, the laminated sheet waste is subjected to waste treatment by being burnt, or is subjected to waste treatment by being brought into a waste disposal site. However, such waste treatment is not preferred from the viewpoint of reduction in environmental load.

In view of the foregoing, such waste treatment for the laminated sheet waste as described above needs to be minimized. There has been desired an investigation on the recycling of laminated sheet materials as means for reducing such laminated sheet waste treatment.

With regard to an acrylic pressure-sensitive adhesive to be incorporated into the pressure-sensitive adhesive tape, there is a report of a method including designing the composition of the acrylic pressure-sensitive adhesive to specific composition to separate the pressure-sensitive adhesive.

There is a report of a technology including re-macerating the pressure-sensitive adhesive layer of a pressure-sensitive adhesive tape in a process for the turning of the tape into regenerated pulp to make the tape recyclable (Patent Literature 1). In the technology, the composition of a pressure-sensitive adhesive for forming the pressure-sensitive adhesive layer is formed of an alkoxyalkyl (meth)acrylate (from 7 wt % to 30 wt %), a caprolactone adduct of (meth)acrylic acid (from 1 wt % to 15 wt %), a (meth)acrylic acid alkyl ester monomer having an alkyl group having 4 to 18 carbon atoms (from 20 wt % to 70 wt %), an ethylenically unsaturated carboxylic acid-containing monomer (from 7 wt % to 20 wt %), and a monomer copolymerizable with these components (from 1 wt % to 15 wt %), and the pressure-sensitive adhesive having the specific composition is prepared to enable the maceration of the layer in an aqueous solution of NaOH having a concentration of 18%.

There is a report of a technology including subjecting an adhesive for labeling to be suitably peeled at the time of the recycling of a plastic bottle to saponification treatment with an alkaline aqueous solution to detach the adhesive (Patent Literature 2). In the technology, a potentially swelling component (a random, block, or graft copolymer containing 35 wt % to 90 wt % of a lower alkyl ester of acrylic acid and/or maleic acid) is incorporated into the adhesive to enable the detachment of the adhesive through the saponification treatment with the alkaline aqueous solution or a solution obtained by adding methanol or ethanol to the solution.

There is a report of a technology including immersing a heat-sensitive pressure-sensitive adhesive label to be suitably peeled at the time of the recycling of a plastic bottle in a hot aqueous solvent at 60° C. or more to cause the pressure-sensitive adhesive of the label to self-peel (Patent Literature 3). In the technology, a heat-sensitive pressure-sensitive adhesive composition containing an acrylic acid ester copolymerized product as a polymer material, a heat-expanding agent, polyvinyl alcohol having a saponification degree of 95 mol % or more, and a cross-linking agent or a curing agent are incorporated into the pressure-sensitive adhesive to cause the pressure-sensitive adhesive to self-peel.

However, in the conventional technology for recycling pressure-sensitive adhesive tape materials, in a case where a separation liquid is used for separating the pressure-sensitive adhesive, a large amount of the separation liquid is required. Therefore, additional process steps, such as recovering, recycling, and waste liquid treatment for the separation liquid, are required for recycling the pressure-sensitive adhesive tape materials, so that recycling cost becomes large.

Moreover, the conventional technology for recycling pressure-sensitive adhesive tape materials can be applied only to a pressure-sensitive adhesive tape having a specific pressure-sensitive adhesive designed to have a specific composition. Meanwhile, in a case where the technology for recycling pressure-sensitive adhesive tape materials is to be developed for a large amount of pressure-sensitive adhesive tape waste produced in production sites or the like, the technology is required to be applicable to pressure-sensitive adhesive tapes having many kinds of pressure-sensitive adhesives.

As a matter of course, the technology for recycling pressure-sensitive adhesive tape materials is also required to be capable of easily separating a base material and a pressure-sensitive adhesive for forming the pressure-sensitive adhesive tape from each other.

### CITATION LIST

### Patent Literature

Patent Literature 1: JP 11-241053 A
Patent Literature 2: JP 11-323280 A
Patent Literature 3: JP 07-113067 A

### SUMMARY OF INVENTION

### Technical Problem

An object of the present invention is to provide a laminated sheet processing method capable of easily separating a base material for forming many kinds of laminated sheets, such as pressure-sensitive adhesive tapes, release films, and antistatic films, and a functional layer, such as a pressure-sensitive adhesive layer, a release layer, and an antistatic layer, laminated on the base material, from each other, at low cost. Another object of the present invention is to provide a laminated sheet processing device that is preferably used for such a laminated sheet processing method.

### Solution to Problem

A laminated sheet processing method according to an embodiment of the present invention is directed to a laminated sheet processing method for processing a laminated sheet including a base material layer and a functional layer, and the laminated sheet processing method includes a step (I) of applying a separation liquid to a surface of the functional layer.

According to one embodiment, a step (II) of covering a coated surface to which the separation liquid has been applied in the step (I), with a cover material, is included.

According to one embodiment, the cover material is a backside surface, on an opposite side, of the functional layer as viewed from the base material layer of the laminated sheet.

According to one embodiment, the cover material is the functional layer.

According to one embodiment, a step (III) of applying an aqueous liquid to the coated surface to which the separation liquid has been applied in the step (I), or impregnating the coated surface with an aqueous liquid, is included.

According to one embodiment, a step (IV) of separating a component derived from the functional layer, from the base material layer is included.

According to one embodiment, the separation liquid contains a liquid having a Hansen solubility parameter value of 31 or less, and an alkaline compound, and a concentration of the alkaline compound in the separation liquid is from 0.001 wt % to 10 wt %.

According to one embodiment, the functional layer is formed of at least one kind selected from the group consisting of an acrylic pressure-sensitive adhesive, a urethane-based pressure-sensitive adhesive, a rubber-based pressure-sensitive adhesive, a silicone-based pressure-sensitive adhesive, a release layer, and an antistatic layer.

A laminated sheet processing device according to an embodiment of the present invention includes: feeding means for feeding a laminated sheet including a base material layer and a functional layer; transporting means for transporting the laminated sheet; separation liquid application means for applying a separation liquid to a surface of the functional layer; separation means for separating a component derived from the functional layer, from the base material layer; and recovering means for recovering a layer that remains after the component derived from the functional layer is separated from the base material layer.

According to one embodiment, the laminated sheet processing device according to an embodiment of the present invention includes aqueous liquid application means for applying an aqueous liquid to a coated surface to which the separation liquid has been applied.

According to one embodiment, the laminated sheet processing device according to an embodiment of the present invention includes aging means.

### Advantageous Effects of Invention

The present invention can provide a laminated sheet processing method capable of easily separating a base material for forming many kinds of laminated sheets, such as pressure-sensitive adhesive tapes, release films, and antistatic films, and a functional layer such as a pressure-sensitive adhesive layer, a release layer, and an antistatic layer laminated on the base material, from each other, at low cost. Furthermore, the present invention can provide a laminated sheet processing device which is preferably used for such a laminated sheet processing method.

### BRIEF DESCRIPTION OF THE DRAWINGS

FIG. 1 is a schematic cross-sectional view of a laminated sheet of one embodiment to which a laminated sheet processing method according to an embodiment of the present invention is applicable.

FIG. 2 is a schematic explanatory diagram illustrating one embodiment of the laminated sheet processing method according to the embodiment of the present invention.

FIG. 3 is a schematic explanatory diagram illustrating another embodiment of the laminated sheet processing method according to the embodiment of the present invention.

### DESCRIPTION OF EMBODIMENTS

When the expression “weight” is used herein, the expression may be replaced with “mass” that has been commonly used as an SI unit for representing a weight.

When the expression “(meth)acrylic” is used herein, the expression means “acrylic and/or methacrylic”, when the expression “(meth)acrylate” is used herein, the expression means “acrylate and/or methacrylate”, when the expression “(meth)allyl” is used herein, the expression means “allyl and/or methallyl”, and when the expression “(meth)acrolein” is used herein, the expression means “acrolein and/or methacrolein”.

### <<Laminated Sheet Processing Method>>

A laminated sheet processing method according to an embodiment of the present invention is a method for processing a laminated sheet including a base material layer and a functional layer, and includes a step (I) of applying a separation liquid to a surface of the functional layer. Such a laminated sheet processing method allows a base material and a pressure-sensitive adhesive for forming many kinds of laminated sheets, such as pressure-sensitive adhesive tapes, release films, and antistatic films, to be easily separated from each other at low cost.

The laminated sheet processing method according to one embodiment of the present invention may include any appropriate other step to the extent that the effects of the present invention are not impaired.

The laminated sheet processing method according to one embodiment of the present invention includes a step (II) of covering a coated surface to which the separation liquid has been applied in the step (I), with a cover material.

The laminated sheet processing method according to one embodiment of the present invention includes a step (III) of applying an aqueous liquid to the coated surface to which the separation liquid has been applied in the step (I) or impregnating the coated surface with an aqueous liquid.

The laminated sheet processing method according to one embodiment of the present invention includes a step (IV) of separating a component derived from the functional layer, from the base material layer.

The laminated sheet processing method according to an embodiment of the present invention preferably includes the step (I) and at least one selected from the group consisting of the step (II), the step (III), and the step (IV) because the effects of the present invention can be further expressed.

The laminated sheet processing method according to an embodiment of the present invention more preferably includes the step (I) and the step (II), and at least one selected from the group consisting of the step (III) and the step (IV) because the effects of the present invention can be further expressed.

The laminated sheet processing method according to an embodiment of the present invention still more preferably includes the step (I) and the step (II), and the step (III) and the step (IV) to be performed after the step (I) and the step (II) because the effects of the present invention can be particularly expressed.

A laminated sheet to be processed by the laminated sheet processing method according to an embodiment of the present invention is a laminated sheet that includes a base material layer and a functional layer. The laminated sheet to be processed may include any appropriate other layer to the extent that the effects of the present invention are not impaired as long as the laminated sheet to be processed is a laminated sheet that includes the base material layer and the functional layer. The number of such other layers may be one, or two or more.

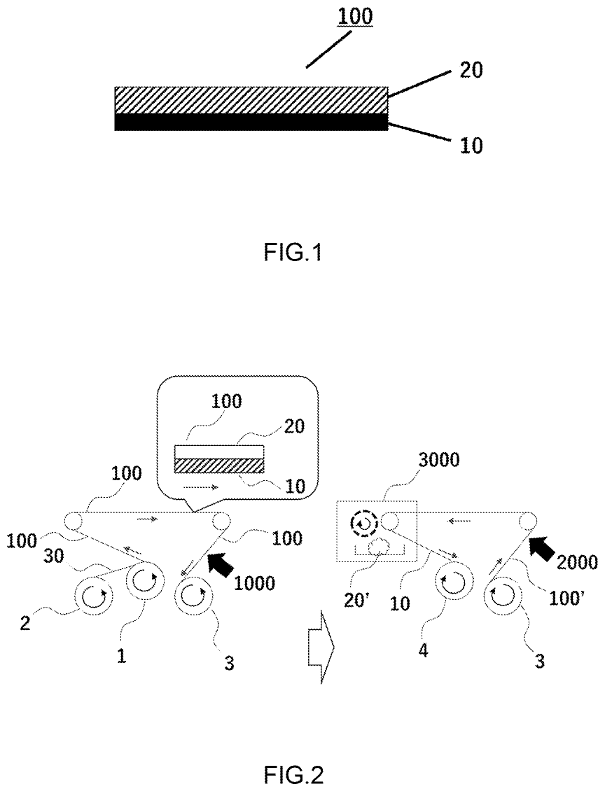

As shown in FIG. 1, according to one embodiment of the laminated sheet to be processed, a laminated sheet 100 is formed of a base material layer 10 and a functional layer 20.

The laminated sheet to be processed may have any appropriate thickness to the extent that the effects of the present invention are not impaired. Such a thickness is preferably from 5 μm to 2000 μm.

### <<Step (I)>>

The step (I) is a step of applying a separation liquid to the surface of the functional layer. Any appropriate means may be adopted as the application means in the step (I) to the extent that the effects of the present invention are not impaired. Examples of such application means include coater application using a coater, such as a gravure roll coater, a reverse roll coater, a kiss roll coater, a dip roll coater, a bar coater, a knife coater, an air knife coater, a spray coater, a comma coater, a direct coater, a roll brush coater, and a curtain coater, so-called “stamp moisturizing” in which a liquid absorbent member such as sponge which has absorbed the separation liquid, and a surface of the functional layer are brought into contact with each other, and metering application in which the separation liquid is applied to the surface of the functional layer by using a metering/movement instrument such as a pipette.

In the description herein, “application” of the separation liquid means an operation in which the separation liquid is brought into contact with the functional layer (pressure-sensitive adhesive layer, release layer, antistatic layer, or the like), and a reaction between the separation liquid and the functional layer is not intended, and means not only the above-described coater application, “stamp moisturizing”, and metering application, but also, for example, an operation of immersing the functional layer in the separation liquid for a short time period, and an operation of causing the functional layer to pass through the separation liquid.

By applying the separation liquid to the surface of the functional layer in the step (I), the functional layer can be separated by a smaller amount of the separation liquid as compared with a case where the functional layer is separated in a state where the laminated sheet is impregnated with the separation liquid, and the base material and the functional layer can be separated from each other at low cost.

Any appropriate temperature may be adopted as a temperature at which the separation liquid is applied to the surface of the functional layer in the step (I) to the extent that the effects of the present invention are not impaired Such a temperature is preferably from 3° ° C. to 43° C., more preferably from 10° C. to 36° C., still more preferably from 15° C. to 31° C., particularly preferably from 18° C. to 28° C., and most preferably from 20° C. to 26° C. because the effects of the present invention can be further expressed.

Using a smaller amount of the separation liquid in the step (I) to the extent that the effects of the present invention are not impaired, is better. The amount of the separation liquid with respect to 1 m² of the surface of the functional layer is preferably 500 g/m² or less, more preferably 400 g/m² or less, still more preferably 300 g/m² or less, particularly preferably 200 g/m² or less, and most preferably 100 g/m² or less, per 20 μm of the thickness of the functional layer. The lower limit value of the amount of the separation liquid to be used in the step (I) is preferably 1 g/m² or more, more preferably 5 g/m² or more, still more preferably 10 g/m² or more, particularly preferably 15 g/m² or more, and most preferably 20 g/m² or more, in consideration of handleability and the like. The amount of the separation liquid to be used in the step (I) tends to be proportional to the thickness of the functional layer. Therefore, for example, in the case of a laminated sheet in which the functional layer has a thickness of 40 μm, a preferable amount of the separation liquid to be used in the step (I) may be considered to be twice the above-described amount. In the case of a laminated sheet in which the functional layer has a thickness of 10 μm, a preferable amount of the separation liquid to be used in the step (I) may be considered to be half the above-described amount.

In the step (I), after the separation liquid has been applied to the surface of the functional layer, aging may be performed at any appropriate temperature for any appropriate time period.

### <Separation Liquid>

As the separation liquid, any appropriate separation liquid may be adopted to the extent that the effects of the present invention are not impaired. The separation liquid preferably contains a liquid having a Hansen solubility parameter value of 31 or less, and an alkaline compound, and the concentration of the alkaline compound is from 0.001 wt % to 10 wt % because the effects of the present invention can be further expressed.

The term “liquid” as used in the present invention refers to a product that is a liquid at normal temperature and normal pressure, and general examples thereof include water, an alcohol, and other various solvents.

The number of kinds of the liquids each having a Hansen solubility parameter value of 31 or less in the separation liquid may be only one, or two or more.

The number of kinds of the alkaline compounds in the separation liquid may be only one, or two or more.

In a case where the separation liquid contains a liquid having a Hansen solubility parameter value of 31 or less, and an alkaline compound, and the concentration of the alkaline compound is from 0.001 wt % to 10 wt %, the base material and the functional layer for forming many kinds of laminated sheets, such as pressure-sensitive adhesive tapes, release films, and antistatic films, can be easily separated from each other.

The term “Hansen solubility parameter value” as used in the present invention refers to a parameter value obtained by dividing a Hildebrand solubility parameter value into three components, that is, a dispersion term (δ_{D}), a polar term (δ_{P}), and a hydrogen bond term (δ_{H}), and considering the polarity of a substance, and may be abbreviated as HSP value. The dispersion term (a term concerning a van der Waals force), the polar term (a term concerning a dipole moment), and the hydrogen bond term (a term concerning a hydrogen bond) may be represented with three-dimensional coordinates.

The Hansen solubility parameter value of a mixed liquid of two or more kinds of liquids may be determined from the following equation (1) as the weighted average “m” of the HSP values of the respective solvents:

m=δ1ϕ1+δ2ϕ2 (1)

where δ1 and δ2 represent the HSP values of the respective liquid components, and ϕ1 and ϕ2 represent the volume fractions of the respective liquid components.

The Hansen solubility parameter values of the respective solvents are recorded in “HSPiP version 5,” and a value estimated from “HSPiP version 5” is used for a solvent that is not recorded therein.

The Hansen solubility parameter value of the liquid in the separation liquid is 31 or less, preferably 28 or less, and more preferably 25 or less. The lower limit of the Hansen solubility parameter value of the liquid in the separation liquid is preferably 7 or more, more preferably 10 or more, and still more preferably 13 or more. In a case where the Hansen solubility parameter value of the liquid in the separation liquid falls within the above-described range, the base material and the functional layer for forming many kinds of laminated sheets, such as pressure-sensitive adhesive tapes, release films, and antistatic films, can be more easily separated from each other. In a case where the Hansen solubility parameter value of the liquid in the separation liquid is more than 31, permeability of the separation liquid into the functional layer may deteriorate, and the base material layer and the functional layer may not be easily separated from each other. Meanwhile, in a case where the Hansen solubility parameter value of the liquid in the separation liquid is less than 7, the permeability of the separation liquid into the functional layer may similarly deteriorate although the degree of the deterioration is smaller as compared with a case where the Hansen solubility parameter value is more than 31, and the base material layer and the functional layer may not be easily separated from each other.

Typical examples of the liquid that is contained in the separation liquid and that has a Hansen solubility parameter value of 31 or less as a single liquid include the following liquids.
methanol (HSP value=29.6)
ethanol (HSP value=26.5)
1-propanol (HSP value=24.6)
2-propanol (IPA) (HSP value=23.6)
1-butanol (HSP value=23.2)
1-pentanol (HSP value=21.7)
1-hexanol (HSP value=21.2)
diethylene glycol (HSP value=27.9)
dipropylene glycol (HSP value=26.4)

Those liquids may be used alone or in combination thereof. In addition to the liquid having a Hansen solubility parameter value of 31 or less, the liquid serving as a single liquid, a mixed liquid obtained by combining a plurality of liquids may be used as long as “m” in the formula (1) serving as the Hansen solubility parameter value of the mixed liquid is 31 or less. For example, a liquid obtained by mixing water (HSP value=47.8) and ethanol (HSP value=26.5) at a ratio “water/ethanol” of 20%/80% in terms of volume fraction may be used because its “m” is equal to 30.76.

Examples of a solvent that may be used in the mixed liquid obtained by combining a plurality of liquids include: water; hydrocarbons, such as benzene, toluene, styrene, hexane, and cyclohexane; ketones, such as acetone; esters, such as ethyl acetate; ethers, such as tetrahydrofuran; nitriles, such as acetonitrile; amines, such as aniline; carboxylic acids, such as acetic acid; and terpenes, such as d-limonene.

Any appropriate alkaline compound may be adopted as the alkaline compound in the separation liquid to the extent that the effects of the present invention are not impaired. Examples of such an alkaline compound include: hydroxides or carbonates of alkali metals or alkaline earth metals, such as potassium hydroxide, sodium hydroxide, and calcium hydroxide; and metal alkoxides, such as sodium methoxide and ethoxide, and sodium butoxide, and the alkaline compound is preferably at least one selected from the group consisting of potassium hydroxide and sodium hydroxide.

The concentration of the alkaline compound in the separation liquid is from 0.001 wt % to 10 wt %, preferably from 0.01 wt % to 5 wt %, and more preferably from 0.1 wt % to 1 wt %. In a case where the concentration of the alkaline compound in the separation liquid falls within the above-described range, the base material and the functional layer for forming many kinds of laminated sheets, such as pressure-sensitive adhesive tapes, release films, and antistatic films, can be easily separated from each other.

Another additive may be contained in the separation liquid. Any appropriate additive may be adopted as the other additive to the extent that the effects of the present invention are not impaired. Various known additives, such as an ionic surfactant, a nonionic surfactant, a chelating agent, a solubilizing agent, a slurrying agent, and an antifoaming agent may be each added as such an additive.

### <<Step (II)>>

The step (II) is a step of covering the coated surface to which the separation liquid has been applied in the step (I), with a cover material. By covering the coated surface to which the separation liquid has been applied in the step (I), with a cover material, the separation liquid is uniformly spread over a wide range of the surface of the functional layer, and the separation liquid can be spread over a wide range of the surface of the functional layer even if an amount of the separation liquid is small. Furthermore, by covering the coated surface with the cover material, evaporation of the separation liquid can be inhibited, and therefore, a good reaction field between the functional layer and the separation liquid is formed, and the base material and the functional layer for forming many kinds of laminated sheets, such as pressure-sensitive adhesive tapes, release films, and antistatic films, can be easily separated from each other at low cost.

In a case where the laminated sheet processing method according to the embodiment of the present invention does not include the step (II), the separation liquid may non-uniformly aggregate on the coated surface to which the separation liquid has been applied in the step (I), or evaporate.

Any appropriate member may be adopted as the cover material to the extent that the effects of the present invention are not impaired. Examples of such a member include resin members, metal members, glass members, and rubber members.

In one embodiment of the step (II), as viewed from the base material layer of the laminated sheet, the cover material is a backside surface, on the opposite side, of the functional layer. In the embodiment including the step (II), for example, as shown in FIG. 2, firstly, a laminated sheet 100 having a separator 30 on the surface of the functional layer 20 is fed from a roll body 1 while the separator 30 is wound by a separator winding roll 2 (feeding means), the laminated sheet 100 is transported (transporting means), a separation liquid 1000 is applied to the functional layer 20 side (step (I)) (separation liquid application means), and the laminated sheet is thereafter wound by a roll body 3 such that the coated surface to which the separation liquid has been applied is on the inner side and the base material layer 10 is on the outer side (step (II)). Thus, the coated surface to which the separation liquid 1000 has been applied is covered such that the backside surface, on the opposite side, of the functional layer 20 serves as a cover material as viewed from the base material layer 10 of the laminated sheet 100.

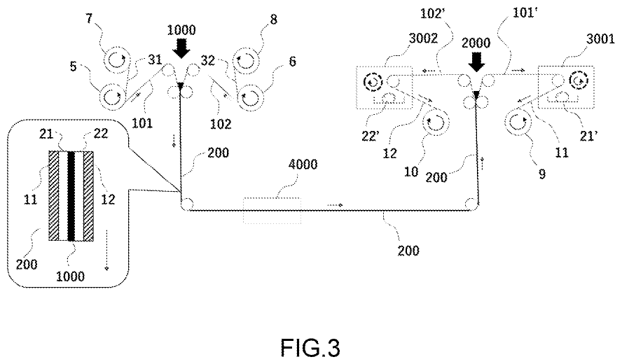

In another embodiment of the step (II), the cover material is the functional layer. In the embodiment including the step (II), for example, as shown in FIG. 3, laminated sheets 101, 102 having separators 31, 32 on the surfaces of functional layers 21, 22 are fed from roll bodies 5, 6 while the separators 31, 32 are wound by separator winding rolls 7, 8, respectively, and the separation liquid 1000 is applied to the functional layer 21, 22 sides of the laminated sheets 101, 102, respectively (step (I)), and the functional layers 21, 22 side portions of the laminated sheets 101, 102, respectively, are adhered to each other (step (II)), to form a laminate 200 in which the two laminated sheets 101, 102 are adhered to each other through the separation liquid 1000. Thus, the coated surface to which the separation liquid 1000 has been applied is covered such that the functional layers 21, 22 of the laminated sheets 101, 102, respectively, serve as the cover material.

In the step (II), after the coated surface to which the separation liquid has been applied is covered with the cover material, aging may be performed at any appropriate temperature for any appropriate time period by aging means.

### <<Step (III), Step (IV)>

The step (III) is a step of applying an aqueous liquid to the coated surface to which the separation liquid has been applied in the step (I) or impregnating the coated surface with an aqueous liquid. The step (IV) is a step of separating a component derived from the functional layer, from the base material layer.

The step (III) is preferably performed after the step (II).

The step (IV) is preferably performed after the step (II). The step (IV) may be performed after the step (III) or may be performed simultaneously with the step (III).

The step (III) is a step to be performed for easier separation through the effect that, for example, the aqueous liquid enters an interface between the layers by osmotic pressure, or tackiness of a pressure-sensitive adhesive or a shearing force at a time when a swelling material contracts is eliminated since the aqueous liquid is further applied to the functional layer that has become more easily separable from the base material layer through reaction with the separation liquid, or the functional layer is impregnated with the aqueous liquid.

Any appropriate aqueous liquid may be adopted as the aqueous liquid used in the step (III) to the extent that the effects of the present invention are not impaired. Such an aqueous liquid is preferably water because the effects of the present invention can be further expressed.

Any appropriate means may be adopted as the application means in the step (III) to the extent that the effects of the present invention are not impaired. Examples of such application means include a coater application using a coater, such as a gravure roll coater, a reverse roll coater, a kiss roll coater, a dip roll coater, a bar coater, a knife coater, an air knife coater, a spray coater, a comma coater, a direct coater, a roll brush coater, and a curtain coater, so-called “stamp moisturizing” in which a liquid absorbent member such as sponge which has absorbed the aqueous liquid, and the coated surface to which the separation liquid has been applied in the step (I) are brought into contact with each other, and metering application in which the aqueous liquid is applied to the coated surface to which the separation liquid has been applied in the step (I) by using a metering/movement instrument such as a pipette.

Any appropriate means may be adopted as impregnation means in the step (III) to the extent that the effects of the present invention are not impaired. Examples of such impregnation means include impregnation in a bath containing the aqueous liquid.

In the step (III), any appropriate temperature may be adopted as a temperature at which the aqueous liquid is applied to the coated surface to which the separation liquid has been applied in the step (I) or the coated surface is impregnated with the aqueous liquid to the extent that the effects of the present invention are not impaired. Such a temperature is preferably from 3° ° C. to 43° C., more preferably from 10° ° C. to 36° C., still more preferably from 15° C. to 31° C., particularly preferably from 18° ° C. to 28° C., and most preferably from 20° ° C. to 26° C. because the effects of the present invention can be further expressed.

Any appropriate means may be adopted as separation means in the step (IV) to the extent that the effects of the present invention are not impaired. Examples of such separation means include a method in which rubbing is performed by a rotary body such as a rubber roll or a metal roll, a method in which scraping is performed by using a member, such as a brush, a scraper, or a knife, having a sharp tip, and a method in which blowing is performed by high-pressure air, high-pressure water, or the like.

In a case where the laminated sheet processing method according to the embodiment of the present invention includes the step (II), and the cover material is a backside surface, on the opposite side, of the functional layer as viewed from the base material layer of the laminated sheet in the step (II) as described above, aging is performed on the roll body 3 obtained in the above-described steps (I), (II) at any appropriate temperature for any appropriate time period as required (aging means), a laminated sheet 100 is thereafter fed from the roll body 3, an aqueous liquid 2000 is applied to the functional layer 20 that has become easily separable from the base material layer 10 through reaction with the separation liquid 1000 (step (III)) (aqueous liquid application means), and a component 20 derived from the functional layer is thereafter separated from the base material layer 10 by a separation device 3000 (step (IV)) (separation means), according to the embodiment including the step (III) and the step (IV), as shown in FIG. 2. The base material layer 10 is wound by a roll 4 and recovered (recovering means).

In a case where the laminated sheet processing method according to the embodiment of the present invention includes the step (II), and the cover material is the functional layer in the step (II) as described above, aging is performed for the laminate 200 in which the two laminated sheets 101, 102 obtained in the above-described steps (I), (II) are adhered to each other through the separation liquid 1000, at any appropriate temperature for any appropriate time period as required (aging device 4000), two laminated sheets 101′, 102′ are thereafter separated and the aqueous liquid 2000 is applied thereto (step (III)) (aqueous liquid application means), and components 21′, 22′ derived from the functional layers are thereafter separated from base material layers 11, 12 by separation devices 3001, 3002 (step (IV)), according to the embodiment including the step (III) and the step (IV), as shown in FIG. 3. The base material layers 11, 12 are wound by rolls 9, 10, respectively, and recovered (recovering means).

In FIG. 3, the step (III) and the step (IV) may be simultaneously performed in a manner in which, after the two laminated sheets 101′, 102′ are separated from each other, the two laminated sheets 101′, 102′ are each immersed in a water-washing bath instead of application of the aqueous liquid 2000, and the components derived from the functional layers are separated. Thereafter, the base material layers 11, 12 may be wound and recovered.

### <<Laminated Sheet Processing Device>>

A laminated sheet processing device according to an embodiment of the present invention is a processing device that is preferably used for the laminated sheet processing method according to the embodiment of the present invention. As described with reference to FIG. 2, FIG. 3, the laminated sheet processing device includes feeding means for feeding a laminated sheet including the base material layer and the functional layer, transporting means for transporting the laminated sheet, separation liquid application means for applying the separation liquid to the surface of the functional layer, separation means for separating a component derived from the functional layer, from the base material layer, and recovering means for recovering a layer that remains after the component derived from the functional layer is separated from the base material layer.

One embodiment of the laminated sheet processing device according to the embodiment of the present invention includes, as described with reference to FIG. 2, FIG. 3, aqueous liquid application means for applying the aqueous liquid to the coated surface to which the separation liquid has been applied.

One embodiment of the laminated sheet processing device according to the embodiment of the present invention includes aging means, as described with reference to FIG. 2, FIG. 3.

### <<Laminated Sheet to be Processed>>

The laminated sheet to be processed by the laminated sheet processing method according to the embodiment of the present invention is a laminated sheet that includes the base material layer and the functional layer. Any appropriate functional layer may be adopted as the functional layer to the extent that the effects of the present invention are not impaired as long as the functional layer is applicable to the processing method of the present invention. Examples of such a functional layer include a pressure-sensitive adhesive layer, a release layer, and an antistatic layer. The release layer is typically a silicone-treated layer. Therefore, examples of the laminated sheet to be processed by the laminated sheet processing method according to the embodiment of the present invention include a pressure-sensitive adhesive tape including the base material layer and a pressure-sensitive adhesive layer, a release film including the base material layer and a release layer, and an antistatic film including the base material layer and an antistatic layer. The laminated sheet to be processed may have any appropriate other layer to the extent that the effects of the present invention are not impaired as long as the laminated sheet includes the base material layer and the functional layer. The number of such other layers may be one, or two or more.

Any appropriate thickness may be adopted as a thickness of the laminated sheet to be processed to the extent that the effects of the present invention are not impaired. Such a thickness is preferably from 5 μm to 2000 μm.

Examples of such a laminated sheet include a pressure-sensitive adhesive tape including the base material layer and a pressure-sensitive adhesive layer, a release film including the base material layer and a release layer, and an antistatic film including the base material layer and an antistatic layer, as described above. Any appropriate pressure-sensitive adhesive tape, release film, and antistatic film may be adopted as the pressure-sensitive adhesive tape, the release film, and the antistatic film, respectively, to the extent that the effects of the present invention are not impaired. A pressure-sensitive adhesive tape including the base material layer and a pressure-sensitive adhesive layer will be described below as a typical example of the laminated sheet.

### <<Base Material Layer>>

A base material layer formed from any appropriate material may be adopted as the base material layer to the extent that the effects of the present invention are not impaired. Examples of such a material include a plastic film, a nonwoven fabric, paper, metal foil, a woven fabric, a rubber sheet, a foamed sheet, and a laminate thereof (in particular, a laminate including the plastic film).

Examples of the plastic film include: a plastic film including a polyester-based resin, such as polyethylene terephthalate (PET), polyethylene naphthalate (PEN), or polybutylene terephthalate (PBT); a plastic film including an olefin-based resin containing an α-olefin as a monomer component, such as polyethylene (PE), polypropylene (PP), polymethylpentene (PMP), an ethylene-propylene copolymer, or an ethylene-vinyl acetate copolymer (EVA); a plastic film including polyvinyl chloride (PVC); a plastic film including a vinyl acetate-based resin; a plastic film including polycarbonate (PC); a plastic film including polyphenylene sulfide (PPS); a plastic film including an amide-based resin, such as polyamide (nylon) or wholly aromatic polyamide (aramid); a plastic film including a polyimide-based resin; a plastic film including polyether ether ketone (PEEK); a plastic film including an olefin-based resin, such as polyethylene (PE) or polypropylene (PP); a plastic film including a fluorine-based resin, such as polytetrafluoroethylene, polychlorotrifluoroethylene, polyvinyl fluoride, polyvinylidene fluoride, a tetrafluoroethylene-hexafluoropropylene copolymer, or a chlorofluoroethylene-vinylidene fluoride copolymer; and triacetyl cellulose (TAC).

Examples of the nonwoven fabric include: nonwoven fabrics based on natural fibers each having heat resistance such as a nonwoven fabric including Manila hemp; and synthetic resin nonwoven fabrics, such as a polypropylene resin nonwoven fabric, a polyethylene resin nonwoven fabric, and an ester-based resin nonwoven fabric.

The number of the base material layers may be only one, or two or more.

The thickness of the base material layer is preferably from 5 μm to 250 μm because the effects of the present invention can be further expressed.

The base material layer may be subjected to surface treatment. Examples of the surface treatment include corona treatment, plasma treatment, chromic acid treatment, ozone exposure, flame exposure, high-voltage electric shock exposure, ionizing radiation treatment, and coating treatment with an undercoating agent.

The base material layer may be subjected to backside surface treatment.

The base material layer may contain any appropriate other additive to the extent that the effects of the present invention are not impaired.

### <<Pressure-Sensitive Adhesive Layer>>

Any appropriate pressure-sensitive adhesive layer may be adopted as the pressure-sensitive adhesive layer to the extent that the effects of the present invention are not impaired. The number of the pressure-sensitive adhesive layers may be only one, or two or more.

The thickness of the pressure-sensitive adhesive layer is preferably from 1 μm to 2000 μm because the effects of the present invention can be further expressed.

The pressure-sensitive adhesive layer preferably includes at least one kind selected from the group consisting of: an acrylic pressure-sensitive adhesive; a urethane-based pressure-sensitive adhesive; a rubber-based pressure-sensitive adhesive; and a silicone-based pressure-sensitive adhesive.

The pressure-sensitive adhesive layer may be formed by any appropriate method. Examples of such a method include a method including: applying a pressure-sensitive adhesive composition (at least one kind selected from the group consisting of: an acrylic pressure-sensitive adhesive composition; a urethane-based pressure-sensitive adhesive composition; a rubber-based pressure-sensitive adhesive composition; and a silicone-based pressure-sensitive adhesive composition) onto any appropriate base material; heating and drying the obtained product as required; and curing the obtained product as required to form the pressure-sensitive adhesive layer on the base material. Examples of such an application method include methods using a gravure roll coater, a reverse roll coater, a kiss roll coater, a dip roll coater, a bar coater, a knife coater, an air knife coater, a spray coater, a comma coater, a direct coater, a roll brush coater, and a curtain coater.

### <Acrylic Pressure-Sensitive Adhesive>

The acrylic pressure-sensitive adhesive is formed from the acrylic pressure-sensitive adhesive composition.

The acrylic pressure-sensitive adhesive composition preferably contains an acrylic polymer and a cross-linking agent because the effects of the present invention can be further expressed.

The acrylic polymer is what may be called a base polymer in the field of acrylic pressure-sensitive adhesives. The number of kinds of the acrylic polymers may be only one, or two or more.

The content of the acrylic polymer in the acrylic pressure-sensitive adhesive composition is preferably from 50 wt % to 100 wt %, more preferably from 60 wt % to 100 wt %, still more preferably from 70 wt % to 100 wt %, particularly preferably from 80 wt % to 100 wt %, most preferably from 90 wt % to 100 wt % in terms of solid content.

Any appropriate acrylic polymer may be adopted as the acrylic polymer to the extent that the effects of the present invention are not impaired.

The weight-average molecular weight of the acrylic polymer is preferably from 100,000 to 3,000,000, more preferably from 150,000 to 2,000,000, still more preferably from 200,000 to 1,500,000, particularly preferably from 250,000 to 1,000,000 because the effects of the present invention can be further expressed.

The acrylic polymer is preferably an acrylic polymer formed through polymerization from a composition (A) containing a (meth)acrylic acid alkyl ester whose alkyl ester moiety has an alkyl group having 4 to 12 carbon atoms (component “a”), and at least one kind selected from the group consisting of: a (meth)acrylic acid ester having a OH group; and (meth)acrylic acid (component “b”) because the effects of the present invention can be further expressed. The number of kinds of the components “a” and the number of kinds of the components “b” may each be independently only one, or two or more.

Examples of the (meth)acrylic acid alkyl ester whose alkyl ester moiety has an alkyl group having 4 to 12 carbon atoms (component “a”) include n-butyl (meth)acrylate, isobutyl (meth)acrylate, s-butyl (meth)acrylate, t-butyl (meth)acrylate, pentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, and dodecyl (meth)acrylate. Of those, n-butyl (meth)acrylate and 2-ethylhexyl (meth)acrylate are preferred, and n-butyl acrylate and 2-ethylhexyl acrylate are more preferred because the effects of the present invention can be further expressed.

Examples of the at least one kind selected from the group consisting of: a (meth)acrylic acid ester having a OH group; and (meth)acrylic acid (component “b”) include: (meth)acrylic acid esters each having a OH group, such as hydroxyethyl (meth)acrylate, hydroxypropyl (meth)acrylate, and hydroxybutyl (meth)acrylate; and (meth)acrylic acid. Of those, hydroxyethyl (meth)acrylate and (meth)acrylic acid are preferred, and hydroxyethyl acrylate and acrylic acid are more preferred because the effects of the present invention can be further expressed.

The composition (A) may contain a copolymerizable monomer except the component “a” and the component “b”. The number of kinds of the copolymerizable monomers may be only one, or two or more. Examples of such copolymerizable monomer include: carboxyl group-containing monomers (provided that (meth)acrylic acid is excluded), such as itaconic acid, maleic acid, fumaric acid, crotonic acid, isocrotonic acid, and acid anhydrides thereof (e.g., acid anhydride group-containing monomers, such as maleic anhydride and itaconic anhydride); amide group-containing monomers, such as (meth)acrylamide, N,N-dimethyl (meth)acrylamide, N-methylol (meth)acrylamide, N-methoxymethyl (meth)acrylamide, N-butoxymethyl (meth)acrylamide, and N-hydroxyethyl (meth)acrylamide; amino group-containing monomers, such as aminoethyl (meth)acrylate, dimethylaminoethyl (meth)acrylate, and t-butylaminoethyl (meth)acrylate; epoxy group-containing monomers, such as glycidyl (meth)acrylate and methylglycidyl (meth)acrylate; cyano group-containing monomers, such as acrylonitrile and methacrylonitrile; heterocycle-containing vinyl-based monomers, such as N-vinyl-2-pyrrolidone, (meth)acryloylmorpholine, N-vinylpiperidone, N-vinylpiperazine, N-vinylpyrrole, N-vinylimidazole, vinylpyridine, vinylpyrimidine, and vinyloxazole; sulfonic acid group-containing monomers such as sodium vinylsulfonate; phosphoric acid group-containing monomers such as 2-hydroxyethylacryloyl phosphate; imide group-containing monomers, such as cyclohexylmaleimide and isopropylmaleimide; isocyanate group-containing monomers such as 2-methacryloyloxyethyl isocyanate; (meth)acrylic acid esters each having an alicyclic hydrocarbon group, such as cyclopentyl (meth)acrylate, cyclohexyl (meth)acrylate, and isobornyl (meth)acrylate; (meth)acrylic acid esters each having an aromatic hydrocarbon group, such as phenyl (meth)acrylate, phenoxyethyl (meth)acrylate, and benzyl (meth)acrylate; vinyl esters, such as vinyl acetate and vinyl propionate; aromatic vinyl compounds, such as styrene and vinyltoluene; olefins and dienes, such as ethylene, butadiene, isoprene, and isobutylene; vinyl ethers such as a vinyl alkyl ether; and vinyl chloride.

A polyfunctional monomer may also be adopted as the copolymerizable monomer. The “polyfunctional monomer” refers to a monomer having two or more ethylenically unsaturated groups in a molecule thereof. Any appropriate ethylenically unsaturated groups may be adopted as the ethylenically unsaturated groups to the extent that the effects of the present invention are not impaired. Examples of such ethylenically unsaturated group include radical-polymerizable functional groups, such as a vinyl group, a propenyl group, an isopropenyl group, a vinyl ether group (vinyloxy group), and an allyl ether group (allyloxy group). Examples of the polyfunctional monomer include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, and urethane acrylate. The number of kinds of such polyfunctional monomers may be only one, or two or more.

A (meth)acrylic acid alkoxyalkyl ester may also be adopted as the copolymerizable monomer. Examples of the (meth)acrylic acid alkoxyalkyl ester include 2-methoxyethyl (meth)acrylate, 2-ethoxyethyl (meth)acrylate, methoxytriethylene glycol (meth)acrylate, 3-methoxypropyl (meth)acrylate, 3-ethoxypropyl (meth)acrylate, 4-methoxybutyl (meth)acrylate, and 4-ethoxybutyl (meth)acrylate. The number of kinds of the (meth)acrylic acid alkoxyalkyl esters may be only one, or two or more.

The content of the (meth)acrylic acid alkyl ester whose alkyl ester moiety has an alkyl group having 4 to 12 carbon atoms (component “a”) is preferably 50 wt % or more, more preferably from 60 wt % to 100 wt %, still more preferably from 70 wt % to 100 wt %, particularly preferably from 80 wt % to 100 wt % with respect to the total amount (100 wt %) of the monomer components for forming the acrylic polymer because the effects of the present invention can be further expressed.

The content of the at least one kind selected from the group consisting of: a (meth)acrylic acid ester having a OH group; and (meth)acrylic acid (component “b”) is preferably 0.1 wt % or more, more preferably from 1.0 wt % to 50 wt %, still more preferably from 1.5 wt % to 40 wt %, particularly preferably from 2.0 wt % to 30 wt % with respect to the total amount (100 wt %) of the monomer components for forming the acrylic polymer because the effects of the present invention can be further expressed.

The composition (A) may contain any appropriate other component to the extent that the effects of the present invention are not impaired. Examples of such other component include a polymerization initiator, a chain transfer agent, and a solvent. Any appropriate content may be adopted as the content of each of those other components to the extent that the effects of the present invention are not impaired.

A thermal polymerization initiator, a photopolymerization initiator (photoinitiator), or the like may be adopted as the polymerization initiator in accordance with the kind of a polymerization reaction. The number of kinds of the polymerization initiators may be only one, or two or more.

The thermal polymerization initiator may be preferably adopted at the time of the production of the acrylic polymer by solution polymerization. Examples of such thermal polymerization initiator include an azo-based polymerization initiator, a peroxide-based polymerization initiator (e.g., dibenzoyl peroxide or tert-butyl permaleate), and a redox-based polymerization initiator. Of those thermal polymerization initiators, an azo-based polymerization initiator disclosed in JP 2002-69411 A is particularly preferred. Such azo-based polymerization initiator is preferred because a decomposed product of the polymerization initiator hardly remains as a portion, which serves as a cause for the generation of a heat-generated gas (outgas), in the acrylic polymer. Examples of the azo-based polymerization initiator include 2,2′-azobisisobutyronitrile (hereinafter sometimes referred to as “AIBN”), 2,2′-azobis-2-methylbutyronitrile (hereinafter sometimes referred to as “AMBN”), dimethyl 2,2′-azobis(2-methylpropionate), and 4,4′-azobis-4-cyanovaleric acid. The usage amount of the azo-based polymerization initiator is preferably from 0.01 part by weight to 5.0 parts by weight, more preferably from 0.05 part by weight to 4.0 parts by weight, still more preferably from 0.1 part by weight to 3.0 parts by weight, particularly preferably from 0.15 part by weight to 3.0 parts by weight, most preferably from 0.20 part by weight to 2.0 parts by weight with respect to the total amount (100 parts by weight) of the monomer components for forming the acrylic polymer.

The photopolymerization initiator may be preferably adopted at the time of the production of the acrylic polymer by active energy ray polymerization. Examples of the photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzil-based photopolymerization initiator, a benzophenone-based photopolymerization initiator, a ketal-based photopolymerization initiator, and a thioxanthone-based photopolymerization initiator.

Examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether. Examples of the acetophenone-based photopolymerization initiator include 2,2-diethoxyacetophenone, 2,2-dimethoxy-2-phenylacetophenone, 1-hydroxycyclohexyl phenyl ketone, 4-phenoxydichloroacetophenone, and 4-(t-butyl)dichloroacetophenone. Examples of the α-ketol-based photopolymerization initiator include 2-methyl-2-hydroxypropiophenone and 1-[4-(2-hydroxyethyl)phenyl]-2-methylpropan-1-one. An example of the aromatic sulfonyl chloride-based photopolymerization initiator is 2-naphthalenesulfonyl chloride. An example of the photoactive oxime-based photopolymerization initiator is 1-phenyl-1,1-propanedione-2-(o-ethoxycarbonyl)-oxime. An example of the benzoin-based photopolymerization initiator is benzoin. An example of the benzil-based photopolymerization initiator is benzil. Examples of the benzophenone-based photopolymerization initiator include benzophenone, benzoyl benzoic acid, 3,3′-dimethyl-4-methoxybenzophenone, polyvinylbenzophenone, and α-hydroxycyclohexyl phenyl ketone. An example of the ketal-based photopolymerization initiator is benzyl dimethyl ketal. Examples of the thioxanthone-based photopolymerization initiator include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

The usage amount of the photopolymerization initiator is preferably from 0.01 part by weight to 3.0 parts by weight, more preferably from 0.015 part by weight to 2.0 parts by weight, still more preferably from 0.02 part by weight to 1.5 parts by weight, particularly preferably from 0.025 part by weight to 1.0 part by weight, most preferably from 0.03 part by weight to 0.50 part by weight with respect to the total amount (100 parts by weight) of the monomer components for forming the acrylic polymer.

The acrylic pressure-sensitive adhesive composition may contain a cross-linking agent. When the cross-linking agent is used, the cohesive strength of the acrylic pressure-sensitive adhesive can be improved, and hence the effects of the present invention can be further expressed. The number of kinds of the cross-linking agents may be only one, or two or more.

Examples of the cross-linking agent include a polyfunctional isocyanate-based cross-linking agent, an epoxy-based cross-linking agent, a melamine-based cross-linking agent, and a peroxide-based cross-linking agent, and as well, a urea-based cross-linking agent, a metal alkoxide-based cross-linking agent, a metal chelate-based cross-linking agent, a metal salt-based cross-linking agent, a carbodiimide-based cross-linking agent, an oxazoline-based cross-linking agent, an aziridine-based cross-linking agent, and an amine-based cross-linking agent. Of those, at least one kind selected from the group consisting of: a polyfunctional isocyanate-based cross-linking agent; and an epoxy-based cross-linking agent (component “c”) is preferred because the effects of the present invention can be further expressed.

Examples of the polyfunctional isocyanate-based cross-linking agent include: lower aliphatic polyisocyanates, such as 1,2-ethylene diisocyanate, 1,4-butylene diisocyanate, and 1,6-hexamethylene diisocyanate; alicyclic polyisocyanates, such as cyclopentylene diisocyanate, cyclohexylene diisocyanate, isophorone diisocyanate, hydrogenated tolylene diisocyanate, and hydrogenated xylene diisocyanate; and aromatic polyisocyanates, such as 2,4-tolylene diisocyanate, 2,6-tolylene diisocyanate, 4,4′-diphenylmethane diisocyanate, and xylylene diisocyanate. Examples of the polyfunctional isocyanate-based cross-linking agent also include commercially available products, such as a trimethylolpropane/tolylene diisocyanate adduct (manufactured by Nippon Polyurethane Industry Co., Ltd., product name: “CORONATE L”), a trimethylolpropane/hexamethylene diisocyanate adduct (manufactured by Nippon Polyurethane Industry Co., Ltd., product name: “CORONATE HL”), a product available under the product name “CORONATE HX” (Nippon Polyurethane Industry Co., Ltd.), and a trimethylolpropane/xylylene diisocyanate adduct (manufactured by Mitsui Chemicals, Inc., product name: “TAKENATE 110N”).

Examples of the epoxy-based cross-linking agent (polyfunctional epoxy compound) include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic acid diglycidyl ester, triglycidyl-tris(2-hydroxyethyl) isocyanurate, resorcinol diglycidyl ether, bisphenol-S-diglycidyl ether, and an epoxy-based resin having two or more epoxy groups in a molecule thereof. Examples of the epoxy-based cross-linking agent also include commercially available products such as a product available under the product name “TETRAD-C” (manufactured by Mitsubishi Gas Chemical Company, Inc.).

Any appropriate content may be adopted as the content of the cross-linking agent in the acrylic pressure-sensitive adhesive composition to the extent that the effects of the present invention are not impaired. Such content is, for example, preferably from 0.1 part by weight to 5.0 parts by weight, more preferably from 0.2 part by weight to 4.5 parts by weight, still more preferably from 0.3 part by weight to 4.0 parts by weight, particularly preferably from 0.4 part by weight to 3.5 parts by weight with respect to the solid content (100 parts by weight) of the acrylic polymer because the effects of the present invention can be further expressed.

The acrylic pressure-sensitive adhesive composition may contain any appropriate other component to the extent that the effects of the present invention are not impaired. Examples of such other component include a polymer component except the acrylic polymer, a cross-linking accelerator, a cross-linking catalyst, a silane coupling agent, a tackifier resin (e.g., a rosin derivative, a polyterpene resin, a petroleum resin, or an oil-soluble phenol), an age resistor, an inorganic filler, an organic filler, a metal powder, a colorant (e.g., a pigment or a dye), a foil-like material, a UV absorber, an antioxidant, a light stabilizer, a chain transfer agent, a plasticizer, a softening agent, a surfactant, an antistatic agent, a conductive agent, a stabilizer, a surface lubricant, a leveling agent, a corrosion inhibitor, a heat stabilizer, a polymerization inhibitor, a lubricant, a solvent, and a catalyst.

### <Urethane-Based Pressure-Sensitive Adhesive>

The urethane-based pressure-sensitive adhesive is formed of the urethane-based pressure-sensitive adhesive composition.

The urethane-based pressure-sensitive adhesive composition preferably contains at least one kind selected from the group consisting of: a urethane prepolymer; and a polyol, and a cross-linking agent because the effects of the present invention can be further expressed.

The at least one kind selected from the group consisting of: a urethane prepolymer; and a polyol is what may be called a base polymer in the field of urethane-based pressure-sensitive adhesives. The number of kinds of the urethane prepolymers may be only one, or two or more. The number of kinds of the polyols may be only one, or two or more.

### [Urethane Prepolymer]

The urethane prepolymer is preferably a polyurethane polyol, more preferably a product obtained by allowing one of a polyester polyol (a1) or a polyether polyol (a2) alone, or a mixture of (a1) and (a2) to react with an organic polyisocyanate compound (a3) in the presence or absence of a catalyst.

Any appropriate polyester polyol may be used as the polyester polyol (a1). Such polyester polyol (a1) is, for example, a polyester polyol obtained by allowing an acid component and a glycol component to react with each other. Examples of the acid component include terephthalic acid, adipic acid, azelaic acid, sebacic acid, phthalic anhydride, isophthalic acid, and trimellitic acid. Examples of the glycol component include ethylene glycol, propylene glycol, diethylene glycol, butylene glycol, 1,6-hexane glycol, 3-methyl-1,5-pentanediol, 3,3′-dimethylolheptane, polyoxyethylene glycol, polyoxypropylene glycol, 1,4-butanediol, neopentyl glycol, butylethylpentanediol, and glycerin, trimethylolpropane, or pentaerythritol serving as a polyol component. Other examples of the polyester polyol (a1) include polyester polyols obtained by subjecting lactones, such as polycaprolactone, poly(β-methyl-γ-valerolactone), and polyvalerolactone, to ring-opening polymerization.

Any value in the range of from a low molecular weight to a high molecular weight may be used as the molecular weight of the polyester polyol (a1). The molecular weight of the polyester polyol (a1) is preferably from 100 to 100,000 in terms of number-average molecular weight because the effects of the present invention can be further expressed. When the number-average molecular weight is less than 100, there is a risk in that the reactivity of the polyol becomes higher, and hence the polyol is liable to gel. When the number-average molecular weight is more than 100,000, there is a risk in that the reactivity reduces, and the cohesive strength of the polyurethane polyol itself reduces. The usage amount of the polyester polyol (a1) is preferably from 0 mol % to 90 mol % in the polyols for forming the polyurethane polyol because the effects of the present invention can be further expressed.

Any appropriate polyether polyol may be used as the polyether polyol (a2). Such polyether polyol (a2) is, for example, a polyether polyol obtained by polymerizing an oxirane compound, such as ethylene oxide, propylene oxide, butylene oxide, or tetrahydrofuran, through use of water or a low-molecular weight polyol, such as propylene glycol, ethylene glycol, glycerin, or trimethylolpropane, as an initiator. Such polyether polyol (a2) is specifically, for example, a polyether polyol having 2 or more functional groups, such as polypropylene glycol, polyethylene glycol, or polytetramethylene glycol.

Any value in the range of from a low molecular weight to a high molecular weight may be used as the molecular weight of the polyether polyol (a2). The molecular weight of the polyether polyol (a2) is preferably from 100 to 100,000 in terms of number-average molecular weight because the effects of the present invention can be further expressed. When the number-average molecular weight is less than 100, there is a risk in that the reactivity of the polyol becomes higher, and hence the polyol is liable to gel. When the number-average molecular weight is more than 100,000, there is a risk in that the reactivity reduces, and the cohesive strength of the polyurethane polyol itself reduces. The usage amount of the polyether polyol (a2) is preferably from 0 mol % to 90 mol % in the polyols for forming the polyurethane polyol because the effects of the present invention can be further expressed.

A product obtained by substituting part of the polyether polyol (a2) with, for example, a glycol, such as ethylene glycol, 1,4-butanediol, neopentyl glycol, butylethylpentanediol, glycerin, trimethylolpropane, or pentaerythritol, or a polyvalent amine, such as ethylenediamine, N-aminoethylethanolamine, isophoronediamine, or xylylenediamine, as required may be used in combination.

Only a bifunctional polyether polyol may be used as the polyether polyol (a2), or a polyether polyol having a number-average molecular weight of from 100 to 100,000 and having at least 3 hydroxy groups in a molecule thereof may be partially or wholly used. When the polyether polyol having a number-average molecular weight of from 100 to 100,000 and having at least 3 hydroxy groups in a molecule thereof is partially or wholly used as the polyether polyol (a2), the effects of the present invention can be further expressed, and a balance between the pressure-sensitive adhesive strength and peelability of the pressure-sensitive adhesive layer can become satisfactory. When the number-average molecular weight in such polyether polyol is less than 100, there is a risk in that its reactivity becomes higher, and hence the polyol is liable to gel. In addition, when the number-average molecular weight in such polyether polyol is more than 100,000, there is a risk in that the reactivity reduces, and the cohesive strength of the polyurethane polyol itself reduces. The number-average molecular weight of such polyether polyol is more preferably from 100 to 10,000 because the effects of the present invention can be further expressed.

Any appropriate polyisocyanate compound may be used as the organic polyisocyanate compound (a3). Examples of such organic polyisocyanate compound (a3) include an aromatic polyisocyanate, an aliphatic polyisocyanate, an aromatic aliphatic polyisocyanate, and an alicyclic polyisocyanate.

Examples of the aromatic polyisocyanate include 1,3-phenylene diisocyanate, 4,4′-diphenyl diisocyanate, 1,4-phenylene diisocyanate, 4,4′-diphenylmethane diisocyanate, 2,4-tolylene diisocyanate, 2,6-tolylene diisocyanate, 4,4′-toluidine diisocyanate, 2,4,6-triisocyanatotoluene, 1,3,5-triisocyanatobenzene, dianisidine diisocyanate, 4,4′-diphenyl ether diisocyanate, and 4,4′,4″-triphenylmethane triisocyanate.

Examples of the aliphatic polyisocyanate include trimethylene diisocyanate, tetramethylene diisocyanate, hexamethylene diisocyanate, pentamethylene diisocyanate, 1,2-propylene diisocyanate, 2,3-butylene diisocyanate, 1,3-butylene diisocyanate, dodecamethylene diisocyanate, and 2,4,4-trimethylhexamethylene diisocyanate.

Examples of the aromatic aliphatic polyisocyanate include ω,ω′-diisocyanato-1,3-dimethylbenzene, ω,ω′-diisocyanato-1,4-dimethylbenzene, ω,ω′-diisocyanato-1,4-diethylbenzene, 1,4-tetramethylxylylene diisocyanate, and 1,3-tetramethylxylylene diisocyanate.

Examples of the alicyclic polyisocyanate include 3-isocyanatomethyl-3,5,5-trimethylcyclohexyl isocyanate, 1,3-cyclopentane diisocyanate, 1,3-cyclohexane diisocyanate, 1,4-cyclohexane diisocyanate, methyl-2,4-cyclohexane diisocyanate, methyl-2,6-cyclohexane diisocyanate, 4,4′-methylenebis(cyclohexyl isocyanate), and 1,4-bis(isocyanatomethyl)cyclohexane.

A trimethylolpropane adduct of any such compound as described above, a biuret thereof formed by a reaction with water, a trimer thereof having an isocyanurate ring, or the like may be used as the organic polyisocyanate compound (a3) in combination with the above-mentioned compound.

Any appropriate catalyst may be used as a catalyst that may be used in obtaining the polyurethane polyol. Examples of such catalyst include a tertiary amine-based compound and an organometallic compound.

Examples of the tertiary amine-based compound include triethylamine, triethylenediamine, and 1,8-diazabicyclo(5,4,0)-undecene-7 (DBU).

Examples of the organometallic compound include a tin-based compound and a non-tin-based compound.

Examples of the tin-based compound include dibutyltin dichloride, dibutyltin oxide, dibutyltin dibromide, dibutyltin dimaleate, dibutyltin dilaurate (DBTDL), dibutyltin diacetate, dibutyltin sulfide, tributyltin sulfide, tributyltin oxide, tributyltin acetate, triethyltin ethoxide, tributyltin ethoxide, dioctyltin oxide, tributyltin chloride, tributyltin trichloroacetate, and tin 2-ethylhexanoate.

Examples of the non-tin-based compound include: titanium-based compounds, such as dibutyltitanium dichloride, tetrabutyl titanate, and butoxytitanium trichloride; lead-based compounds, such as lead oleate, lead 2-ethylhexanoate, lead benzoate, and lead naphthenate; iron-based compounds, such as iron 2-ethylhexanoate and iron acetylacetonate; cobalt-based compounds, such as cobalt benzoate and cobalt 2-ethylhexanoate; zinc-based compounds, such as zinc naphthenate and zinc 2-ethylhexanoate; and zirconium-based compounds such as zirconium naphthenate.

When the catalyst is used in obtaining the polyurethane polyol, in a system where the two kinds of polyols, that is, the polyester polyol and the polyether polyol are present, a single catalyst system is liable to cause a problem in that the polyols gel or a reaction solution becomes cloudy owing to a difference in reactivity between the polyols. In view of the foregoing, when two kinds of catalysts are used in obtaining the polyurethane polyol, it becomes easier to control a reaction rate, the selectivity of the catalysts, and the like, and hence such problem can be solved. Examples of the combination of such two kinds of catalysts include: the combination of a tertiary amine-based compound and an organometallic compound; the combination of a tin-based compound and a non-tin-based compound; and the combination of a tin-based compound and another tin-based compound. Of those, the combination of a tin-based compound and another tin-based compound is preferred, and the combination of dibutyltin dilaurate and tin 2-ethylhexanoate is more preferred. A blending ratio “tin 2-ethylhexanoate/dibutyltin dilaurate” is preferably less than 1, more preferably from 0.2 to 0.6 in terms of weight ratio. When the blending ratio is 1 or more, the polyols may be liable to gel owing to a poor balance between the catalytic activities of the catalysts.

When the catalyst is used in obtaining the polyurethane polyol, the usage amount of the catalyst is preferably from 0.01 wt % to 1.0 wt % with respect to the total amount of the polyester polyol (a1), the polyether polyol (a2), and the organic polyisocyanate compound (a3).

When the catalyst is used in obtaining the polyurethane polyol, a reaction temperature is preferably less than 100° C., more preferably from 85° C. to 95° C. When the temperature is 100° C. or more, it may be difficult to control the reaction rate and the cross-linked structure of the polyurethane polyol, and hence a polyurethane polyol having a predetermined molecular weight may be hardly obtained.

No catalyst may be used in obtaining the polyurethane polyol. In that case, the reaction temperature is preferably 100° ° C. or more, more preferably 110° C. or more. In addition, when the polyurethane polyol is obtained in the absence of any catalyst, the polyols (a1) and (a2), and the compound (a3) are preferably allowed to react with each other for 3 hours or more.

A method of obtaining the polyurethane polyol is, for example, (1) a method involving loading the total amount of the polyester polyol, the polyether polyol, the catalyst, and the organic polyisocyanate compound into a flask, or (2) a method involving loading the polyester polyol, the polyether polyol, and the catalyst into a flask, and adding the organic polyisocyanate compound to the mixture. Of those, the method (2) is preferred as a method of obtaining the polyurethane polyol in terms of the control of the reaction.

Any appropriate solvent may be used in obtaining the polyurethane polyol. Examples of such solvent include methyl ethyl ketone, ethyl acetate, toluene, xylene, and acetone. Of those solvents, toluene is preferred.

### [Polyol]

Preferred examples of the polyol include polyester polyol, polyether polyol, polycaprolactone polyol, polycarbonate polyol, and castor oil-based polyol. The polyol is more preferably polyether polyol.

The polyester polyol may be obtained through, for example, an esterification reaction between a polyol component and an acid component.

Examples of the polyol component include ethylene glycol, diethylene glycol, 1,3-butanediol, 1,4-butanediol, neopentyl glycol, 3-methyl-1,5-pentanediol, 2-butyl-2-ethyl-1,3-propanediol, 2,4-diethyl-1,5-pentanediol, 1,2-hexanediol, 1,6-hexanediol, 1,8-octanediol, 1,9-nonanediol, 2-methyl-1,8-octanediol, 1,8-decanediol, octadecanediol, glycerin, trimethylolpropane, pentaerythritol, hexanetriol, and polypropylene glycol. Examples of the acid component include succinic acid, methylsuccinic acid, adipic acid, pimelic acid, azelaic acid, sebacic acid, 1,12-dodecanedioic acid, 1,14-tetradecanedioic acid, dimer acid, 2-methyl-1,4-cyclohexanedicarboxylic acid, 2-ethyl-1,4-cyclohexanedicarboxylic acid, terephthalic acid, isophthalic acid, phthalic acid, 1,4-naphthalenedicarboxylic acid, 4,4′-biphenyldicarboxylic acid, and acid anhydrides thereof.

An example of the polyether polyol is a polyether polyol obtained by subjecting water, a low-molecular polyol (e.g., propylene glycol, ethylene glycol, glycerin, trimethylolpropane, or pentaerythritol), a bisphenol (e.g., bisphenol A), or a dihydroxybenzene (e.g., catechol, resorcin, or hydroquinone) serving as an initiator to addition polymerization with an alkylene oxide, such as ethylene oxide, propylene oxide, or butylene oxide. Specific examples thereof include polyethylene glycol, polypropylene glycol, and polytetramethylene glycol.

An example of the polycaprolactone polyol is a caprolactone-based polyester diol obtained by subjecting a cyclic ester monomer, such as ε-caprolactone or σ-valerolactone, to ring-opening polymerization.

Examples of the polycarbonate polyol include: a polycarbonate polyol obtained by subjecting the polyol component and phosgene to a polycondensation reaction; a polycarbonate polyol obtained by subjecting the polyol component and a carbonate diester, such as dimethyl carbonate, diethyl carbonate, dipropyl carbonate, diisopropyl carbonate, dibutyl carbonate, ethylbutyl carbonate, ethylene carbonate, propylene carbonate, diphenyl carbonate, or dibenzyl carbonate, to transesterification condensation; a copolymerized polycarbonate polyol obtained by using two or more kinds of the polyol components in combination; a polycarbonate polyol obtained by subjecting any of the various polycarbonate polyols and a carboxyl group-containing compound to an esterification reaction; a polycarbonate polyol obtained by subjecting any of the various polycarbonate polyols and a hydroxyl group-containing compound to an etherification reaction; a polycarbonate polyol obtained by subjecting any of the various polycarbonate polyols and an ester compound to a transesterification reaction; a polycarbonate polyol obtained by subjecting any of the various polycarbonate polyols and a hydroxyl group-containing compound to a transesterification reaction; a polyester-based polycarbonate polyol obtained by subjecting any of the various polycarbonate polyols and a dicarboxylic acid compound to a polycondensation reaction; and a copolymerized polyether-based polycarbonate polyol obtained by subjecting any of the various polycarbonate polyols and an alkylene oxide to copolymerization.

An example of the castor oil-based polyol is a castor oil-based polyol obtained by allowing a castor oil fatty acid and the polyol component to react with each other. A specific example thereof is a castor oil-based polyol obtained by allowing a castor oil fatty acid and polypropylene glycol to react with each other.

The number-average molecular weight Mn of the polyols is preferably from 300 to 100,000, more preferably from 400 to 75,000, still more preferably from 450 to 50,000, particularly preferably from 500 to 30,000 because the effects of the present invention can be further expressed.

The polyols preferably contain a polyol (A1) having 3 OH groups and having a number-average molecular weight Mn of from 300 to 100,000 because the effects of the present invention can be further expressed. The number of kinds of the polyols (A1) may be only one, or two or more.

The content of the polyol (A1) in the polyols is preferably 5 wt % or more, more preferably from 25 wt % to 100 wt %, still more preferably from 50 wt % to 100 wt % because the effects of the present invention can be further expressed.

The number-average molecular weight Mn of the polyol (A1) is preferably from 1,000 to 100,000, more preferably more than 1,000 and 80,000 or less, still more preferably from 1,100 to 70,000, still more preferably from 1,200 to 60,000, still more preferably from 1,300 to 50,000, still more preferably from 1,400 to 40,000, still more preferably from 1,500 to 35,000, particularly preferably from 1,700 to 32,000, most preferably from 2,000 to 30,000 because the effects of the present invention can be further expressed.

The polyols may contain a polyol (A2) having 3 or more OH groups and having a number-average molecular weight Mn of 20,000 or less. The number of kinds of the polyols (A2) may be only one, or two or more. The number-average molecular weight Mn of the polyol (A2) is preferably from 100 to 20,000, more preferably from 150 to 10,000, still more preferably from 200 to 7,500, particularly preferably from 300 to 6,000, most preferably from 300 to 5,000 because the effects of the present invention can be further expressed. Preferred examples of the polyol (A2) include a polyol having 3 OH groups (triol), a polyol having 4 OH groups (tetraol), a polyol having 5 OH groups (pentaol), and a polyol having 6 OH groups (hexaol) because the effects of the present invention can be further expressed.

The total amount of the polyol having 4 OH groups (tetraol), the polyol having 5 OH groups (pentaol), and the polyol having 6 OH groups (hexaol) each serving as the polyol (A2) is preferably 70 wt % or less, more preferably 60 wt % or less, still more preferably 40 wt % or less, particularly preferably 30 wt % or less in terms of content in the polyols because the effects of the present invention can be further expressed.

The content of the polyol (A2) in the polyols is preferably 95 wt % or less, more preferably from 0 wt % to 75 wt % because the effects of the present invention can be further expressed.

The content of a polyol having 4 or more OH groups and having a number-average molecular weight Mn of 20,000 or less serving as the polyol (A2) is preferably less than 70 wt %, more preferably 60 wt % or less, still more preferably 50 wt % or less, particularly preferably 40 wt % or less, most preferably 30 wt % or less with respect to the entirety of the polyols because the effects of the present invention can be further expressed.

### [Cross-Linking Agent]

The urethane-based pressure-sensitive adhesive composition preferably contains a cross-linking agent because the effects of the present invention can be further expressed.

The urethane prepolymer and the polyol serving as base polymers may each be a component for the urethane-based pressure-sensitive adhesive composition when combined with the cross-linking agent.

The cross-linking agent to be combined with the urethane prepolymer and the polyol serving as base polymers is preferably a polyfunctional isocyanate-based cross-linking agent because the effects of the present invention can be further expressed.

Any appropriate polyfunctional isocyanate-based cross-linking agent that may be used for a urethanization reaction may be adopted as the polyfunctional isocyanate-based cross-linking agent. Examples of such polyfunctional isocyanate-based cross-linking agent include: lower aliphatic polyisocyanates, such as 1,2-ethylene diisocyanate, 1,4-butylene diisocyanate, and 1,6-hexamethylene diisocyanate; alicyclic polyisocyanates, such as cyclopentylene diisocyanate, cyclohexylene diisocyanate, isophorone diisocyanate, hydrogenated tolylene diisocyanate, and hydrogenated xylene diisocyanate; and aromatic polyisocyanates, such as 2,4-tolylene diisocyanate, 2,6-tolylene diisocyanate, 4,4′-diphenylmethane diisocyanate, and xylylene diisocyanate. Examples of the polyfunctional isocyanate-based cross-linking agent also include commercially available products, such as a trimethylolpropane/tolylene diisocyanate adduct (manufactured by Nippon Polyurethane Industry Co., Ltd., product name: “CORONATE L”), a trimethylolpropane/hexamethylene diisocyanate adduct (manufactured by Nippon Polyurethane Industry Co., Ltd., product name: “CORONATE HL”), a product available under the product name “CORONATE HX” (Nippon Polyurethane Industry Co., Ltd.), and a trimethylolpropane/xylylene diisocyanate adduct (manufactured by Mitsui Chemicals, Inc., product name: “TAKENATE 110N”).

### [Urethane-Based Pressure-Sensitive Adhesive Composition]

The urethane-based pressure-sensitive adhesive composition may contain any appropriate other component to the extent that the effects of the present invention are not impaired. Examples of such other component include a polymer component except the urethane-based prepolymer and the polyol, a cross-linking accelerator, a cross-linking catalyst, a silane coupling agent, a tackifier resin (e.g., a rosin derivative, a polyterpene resin, a petroleum resin, or an oil-soluble phenol), an age resistor, an inorganic filler, an organic filler, a metal powder, a colorant (e.g., a pigment or a dye), a foil-like material, a deterioration-preventing agent, a chain transfer agent, a plasticizer, a softening agent, a surfactant, an antistatic agent, a conductive agent, a stabilizer, a surface lubricant, a leveling agent, a corrosion inhibitor, a heat stabilizer, a polymerization inhibitor, a lubricant, a solvent, and a catalyst.

The urethane-based pressure-sensitive adhesive composition preferably contains a deterioration-preventing agent because the effects of the present invention can be further expressed. The number of kinds of the deterioration-preventing agents may be only one, or two or more.

Preferred examples of the deterioration-preventing agent include an antioxidant, a UV absorber, and a light stabilizer because the effects of the present invention can be further expressed.

Examples of the antioxidant include a radical chain inhibitor and a peroxide decomposer.

Examples of the radical chain inhibitor include a phenol-based antioxidant and an amine-based antioxidant.

Examples of the phenol-based antioxidant include a monophenol-based antioxidant, a bisphenol-based antioxidant, and a polymer-type phenol-based antioxidant. Examples of the monophenol-based antioxidant include 2,6-di-t-butyl-p-cresol, butylated hydroxyanisole, 2,6-di-t-butyl-4-ethylphenol, and stearin-β-(3,5-di-t-butyl-4-hydroxyphenyl)propionate. Examples of the bisphenol-based antioxidant include 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol), and 3,9-bis[1,1-dimethyl-2-[β-(3-t-butyl-4-hydroxy-5-methylphenyl)propionyloxy]ethyl]2,4,8,10-tetraoxaspiro[5,5]undecane. Examples of the polymer-type phenol-based antioxidant include 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis-(4′-hydroxy-3′-t-butylphenyl)butyric acid] glycol ester, 1,3,5-tris(3′,5′-di-t-butyl-4′-hydroxybenzyl)-S-triazine-2,4,6-(1H,3H,5H)trione, and tocopherol.

Examples of the peroxide decomposer include a sulfur-based antioxidant and a phosphorus-based antioxidant. Examples of the sulfur-based antioxidant include dilauryl 3,3′-thiodipropionate, dimyristyl 3,3′-thiodipropionate, and distearyl 3,3′-thiodipropionate. Examples of the phosphorus-based antioxidant include triphenyl phosphite, diphenyl isodecyl phosphite, and phenyl diisodecyl phosphite.

Examples of the UV absorber include a benzophenone-based UV absorber, a benzotriazole-based UV absorber, a salicylic acid-based UV absorber, an oxanilide-based UV absorber, a cyanoacrylate-based UV absorber, and a triazine-based UV absorber.

Examples of the benzophenone-based UV absorber include 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-dimethoxybenzophenone, 2,2′-dihydroxy-4,4′-dimethoxybenzophenone, 2-hydroxy-4-methoxy-5-sulfobenzophenone, and bis(2-methoxy-4-hydroxy-5-benzoylphenyl)methane. Examples of the benzotriazole-based UV absorber include 2-(2′-hydroxy-5′-methylphenyl)benzotriazole, 2-(2′-hydroxy-5′-tert-butylphenyl)benzotriazole, 2-(2′-hydroxy-3′,5′-di-tert-butylphenyl)benzotriazole, 2-(2′-hydroxy-3′-tert-butyl-5′-methylphenyl)-5-chlorobenzotriazole, 2-(2′-hydroxy-3′,5′-di-tert-butylphenyl)-5-chlorobenzotriazole, 2-(2′-hydroxy-3′,5′-di-tert-amylphenyl)benzotriazole, 2-(2′-hydroxy-4′-octoxyphenyl)benzotriazole, 2-[2′-hydroxy-3′-(3″,4″,5″,6″,-tetrahydrophthalimidomethyl)-5′-methylphenyl]benzotriazole, 2,2′-methylenebis[4-(1,1,3,3-tetramethylbutyl)-6-(2H-benzotriazol-2-yl)phenol], and 2-(2′-hydroxy-5′-methacryloxyphenyl)-2H-benzotriazole.

Examples of the salicylic acid-based UV absorber include phenyl salicylate, p-tert-butylphenyl salicylate, and p-octylphenyl salicylate.

Examples of the cyanoacrylate-based UV absorber include 2-ethylhexyl-2-cyano-3,3′-diphenyl acrylate, and ethyl-2-cyano-3,3′-diphenyl acrylate.

Examples of the light stabilizer include a hindered amine-based light stabilizer and a UV stabilizer. Examples of the hindered amine-based light stabilizer include bis(2,2,6,6-tetramethyl-4-piperidyl) sebacate, bis(1,2,2,6,6-pentamethyl-4-piperidyl) sebacate, and methyl-1,2,2,6,6-pentamethyl-4-piperidyl sebacate. Examples of the UV stabilizer include nickel bis(octylphenyl) sulfide, [2,2′-thiobis(4-tert-octylphenolate)]-n-butylamine nickel, nickel complex-3,5-di-tert-butyl-4-hydroxybenzyl-phosphoric acid monoethylate, a benzoate-type quencher, and nickel-dibutyl dithiocarbamate.

[Urethane-Based Polymer Formed from Urethane-Based Pressure-Sensitive Adhesive Composition Containing Urethane Prepolymer and Polyfunctional Isocyanate-Based Cross-Linking Agent]

The number of kinds of the urethane prepolymers may be only one, or two or more. The number of kinds of the polyfunctional isocyanate-based cross-linking agents may be only one, or two or more.

Any appropriate production method may be adopted as a method of forming the urethane-based polymer from the urethane-based pressure-sensitive adhesive composition containing the urethane prepolymer and the polyfunctional isocyanate-based cross-linking agent as long as the production method is a method of producing a urethane-based polymer through use of a so-called “urethane prepolymer” as a raw material.

The number-average molecular weight Mn of the urethane prepolymer is preferably from 3,000 to 1,000,000 because the effects of the present invention can be further expressed.

An equivalent ratio “NCO group/OH group” between an NCO group and a OH group in the urethane prepolymer and the polyfunctional isocyanate-based cross-linking agent is preferably 5.0 or less, more preferably from 0.01 to 4.75, still more preferably from 0.02 to 4.5, particularly preferably from 0.03 to 4.25, most preferably from 0.05 to 4.0 because the effects of the present invention can be further expressed.

The content of the polyfunctional isocyanate-based cross-linking agent is preferably from 0.01 part by weight to 30 parts by weight, more preferably from 0.05 part by weight to 25 parts by weight, still more preferably from 0.1 part by weight to 20 parts by weight, particularly preferably from 0.5 part by weight to 17.5 parts by weight, most preferably from 1 part by weight to 15 parts by weight with respect to 100 parts by weight of the urethane prepolymer because the effects of the present invention can be further expressed.

[Urethane-Based Polymer Formed from Urethane-Based Pressure-Sensitive Adhesive Composition Containing Polyol and Polyfunctional Isocyanate-Based Cross-Linking Agent]

The number of kinds of the polyols may be only one, or two or more. The number of kinds of the polyfunctional isocyanate-based cross-linking agents may be only one, or two or more.

An equivalent ratio “NCO group/OH group” between an NCO group and a OH group in the polyol and the polyfunctional isocyanate-based cross-linking agent is preferably 5.0 or less, more preferably from 0.1 to 3.0, still more preferably from 0.2 to 2.5, particularly preferably from 0.3 to 2.25, most preferably from 0.5 to 2.0 because the effects of the present invention can be further expressed.

The content of the polyfunctional isocyanate-based cross-linking agent is preferably from 1.0 part by weight to 30 parts by weight, more preferably from 1.5 parts by weight to 27 parts by weight, still more preferably from 2.0 parts by weight to 25 parts by weight, particularly preferably from 2.3 parts by weight to 23 parts by weight, most preferably from 2.5 parts by weight to 20 parts by weight with respect to 100 parts by weight of the polyol because the effects of the present invention can be further expressed.

Specifically, the urethane-based polymer formed from the urethane-based pressure-sensitive adhesive composition containing the polyol and the polyfunctional isocyanate-based cross-linking agent is preferably formed by curing the urethane-based pressure-sensitive adhesive composition containing the polyol and the polyfunctional isocyanate-based cross-linking agent. As a method of forming the urethane-based polymer by curing the urethane-based pressure-sensitive adhesive composition containing the polyol and the polyfunctional isocyanate-based cross-linking agent, there may be adopted any appropriate method such as a urethanization reaction method making use of, for example, bulk polymerization or solution polymerization to the extent that the effects of the present invention are not impaired.

A catalyst is preferably used for curing the urethane-based pressure-sensitive adhesive composition containing the polyol and the polyfunctional isocyanate-based cross-linking agent. Examples of such catalyst include an organometallic compound and a tertiary amine compound.

Examples of the organometallic compound may include an iron-based compound, a tin-based compound, a titanium-based compound, a zirconium-based compound, a lead-based compound, a cobalt-based compound, and a zinc-based compound. Of those, an iron-based compound and a tin-based compound are preferred from the viewpoints of a reaction rate and the pot life of the pressure-sensitive adhesive layer.

Examples of the iron-based compound include iron acetylacetonate, iron 2-ethylhexanoate, and Nacem Ferric Iron.

Examples of the tin-based compound include dibutyltin dichloride, dibutyltin oxide, dibutyltin dibromide, dibutyltin maleate, dibutyltin dilaurate, dibutyltin diacetate, dibutyltin sulfide, tributyltin methoxide, tributyltin acetate, triethyltin ethoxide, tributyltin ethoxide, dioctyltin oxide, dioctyltin dilaurate, tributyltin chloride, tributyltin trichloroacetate, and tin 2-ethylhexanoate.

Examples of the titanium-based compound include dibutyltitanium dichloride, tetrabutyl titanate, and butoxytitanium trichloride.

Examples of the zirconium-based compound include zirconium naphthenate and zirconium acetylacetonate.

Examples of the lead-based compound include lead oleate, lead 2-ethylhexanoate, lead benzoate, and lead naphthenate.

Examples of the cobalt-based compound include cobalt 2-ethylhexanoate and cobalt benzoate.

Examples of the zinc-based compound include zinc naphthenate and zinc 2-ethylhexanoate.

Examples of the tertiary amine compound include triethylamine, triethylenediamine, and 1,8-diazabicyclo-(5,4,0)-undecene-7.

The number of kinds of the catalysts may be only one, or two or more. In addition, the catalyst may be used in combination with, for example, a cross-linking retarder. The amount of the catalyst is preferably from 0.005 part by weight to 1.00 part by weight, more preferably from 0.01 part by weight to 0.75 part by weight, still more preferably from 0.01 part by weight to 0.50 part by weight, particularly preferably from 0.01 part by weight to 0.20 part by weight with respect to 100 parts by weight of the polyol because the effects of the present invention can be further expressed.

### <Rubber-Based Pressure-Sensitive Adhesive>

For example, any appropriate rubber-based pressure-sensitive adhesive such as a known rubber-based pressure-sensitive adhesive described in JP 2015-074771 A or the like may be adopted as the rubber-based pressure-sensitive adhesive to the extent that the effects of the present invention are not impaired. The number of kinds thereof may be only one, or two or more. The rubber-based pressure-sensitive adhesive may contain any appropriate component to the extent that the effects of the present invention are not impaired.

### <Silicone-Based Pressure-Sensitive Adhesive>

For example, any appropriate silicone-based pressure-sensitive adhesive such as a known silicone-based pressure-sensitive adhesive described in JP 2014-047280 A or the like may be adopted as the silicone-based pressure-sensitive adhesive to the extent that the effects of the present invention are not impaired. The number of kinds thereof may be only one, or two or more. The silicone-based pressure-sensitive adhesive may contain any appropriate component to the extent that the effects of the present invention are not impaired.

### <<Separator>>

The pressure-sensitive adhesive tape may include a separator in order to, for example, protect the pressure-sensitive adhesive layer. The thickness of the separator is preferably from 5 μm to 250 μm because the effects of the present invention can be further expressed.

The separator includes a resin base material film.

Examples of the resin base material film include: a plastic film including a polyester-based resin, such as polyethylene terephthalate (PET), polyethylene naphthalate (PEN), or polybutylene terephthalate (PBT); a plastic film including an olefin-based resin containing an α-olefin as a monomer component, such as polyethylene (PE), polypropylene (PP), polymethylpentene (PMP), an ethylene-propylene copolymer, or an ethylene-vinyl acetate copolymer (EVA); a plastic film including polyvinyl chloride (PVC); a plastic film including a vinyl acetate-based resin; a plastic film including polycarbonate (PC); a plastic film including polyphenylene sulfide (PPS); a plastic film including an amide-based resin, such as polyamide (nylon) or wholly aromatic polyamide (aramid); a plastic film including a polyimide-based resin; a plastic film including polyether ether ketone (PEEK); a plastic film including an olefin-based resin, such as polyethylene (PE) or polypropylene (PP); a plastic film including a fluorine-based resin, such as polytetrafluoroethylene, polychlorotrifluoroethylene, polyvinyl fluoride, polyvinylidene fluoride, a tetrafluoroethylene-hexafluoropropylene copolymer, or a chlorofluoroethylene-vinylidene fluoride copolymer; and triacetyl cellulose (TAC).

The number of the resin base material films may be only one, or two or more. The resin base material film may be stretched.

The resin base material film may be subjected to surface treatment. Examples of the surface treatment include corona treatment, plasma treatment, chromic acid treatment, ozone exposure, flame exposure, high-voltage electric shock exposure, ionizing radiation treatment, and coating treatment with an undercoating agent.

The resin base material film may contain any appropriate additive to the extent that the effects of the present invention are not impaired.

The separator may have a release layer for increasing its peelability from the pressure-sensitive adhesive layer. When the separator has the release layer, the release layer side thereof is directly laminated on the pressure-sensitive adhesive layer.

Any appropriate formation material may be adopted as a formation material for the release layer to the extent that the effects of the present invention are not impaired. Examples of such formation material include a silicone-based release agent, a fluorine-based release agent, a long-chain alkyl-based release agent, and a fatty acid amide-based release agent. Of those, a silicone-based release agent is preferred. The release layer may be formed as an applied layer.

Any appropriate thickness may be adopted as the thickness of the release layer depending on purposes to the extent that the effects of the present invention are not impaired. Such thickness is preferably from 10 nm to 2,000 nm.

The number of the release layers may be only one, or two or more.

As a silicone-based release layer, there is given, for example, an addition reaction-type silicone resin. Specific examples of the addition reaction-type silicone resin include: KS-774, KS-775, KS-778, KS-779H, KS-847H, and KS-847T manufactured by Shin-Etsu Chemical Co., Ltd.; TPR-6700, TPR-6710, and TPR-6721 manufactured by Toshiba Silicone Co., Ltd.; and SD7220 and SD7226 manufactured by Dow Corning Toray Co., Ltd. The application amount of the silicone-based release layer (after its drying) is preferably from 0.01 g/m² to 2 g/m², more preferably from 0.01 g/m² to 1 g/m², still more preferably from 0.01 g/m² to 0.5 g/m².

The release layer may be formed by, for example, applying the above-mentioned formation material onto any appropriate layer by a hitherto known application method, such as reverse gravure coating, bar coating, or die coating, and then curing the formation material through heat treatment, which is typically performed at from about 120° C. to about 200° C. In addition, as required, the heat treatment and active energy ray irradiation such as UV irradiation may be used in combination.

### EXAMPLES

The present invention is specifically described below by way of Examples. However, the present invention is by no means limited to these Examples. Test and evaluation methods in Examples and the like are as described below. The description “part(s)” means “part(s) by weight” unless otherwise specified, and the description “%” means “wt %” unless otherwise specified. “Room temperature” represents 20° C.

### [Production Example 1]: Preparation of Pressure-Sensitive Adhesive Tape

As the pressure-sensitive adhesive tape, the following ones were prepared.
(1) “E-MASK” series “RP207” (acrylic pressure-sensitive adhesive tape, manufactured by Nitto Denko Corporation)
(2) “E-MASK” series “RP108” (acrylic pressure-sensitive adhesive tape, manufactured by Nitto Denko Corporation)
(3) “REVALPHA” series “No. 3195MS” (acrylic pressure-sensitive adhesive tape, manufactured by Nitto Denko Corporation)
(4) polyimide pressure-sensitive adhesive tape “No. 360UL” (silicone-based pressure-sensitive adhesive tape, manufactured by Nitto Denko Corporation)
(5) OPP packaging tape “No. 3040” (rubber-based pressure-sensitive adhesive tape, manufactured by Nitto Denko Corporation)
(6) release film (manufactured by Toray Industries, Inc., Product name: CERAPEEL (silicone-based))
(7) backside surface-treated film (manufactured by Nitto Denko Corporation, urethane-treated PET)

### [Production Example 2]: Preparation of Separation Liquid

### (Preparation of Separation Liquid (1))

Potassium hydroxide (KOH) was added to 1-butanol (HSP value=23.2) so that an alkali concentration in a separation liquid to be obtained became 5 wt %. Thus, a separation liquid (1) was obtained.

### (Preparation of Separation Liquid (2))

Potassium hydroxide (KOH) was added to 1-butanol (HSP value=23.2) so that an alkali concentration in a separation liquid to be obtained became 1 wt %. Thus, a separation liquid (2) was obtained.

### (Preparation of Separation Liquid (3))

Potassium hydroxide (KOH) was added to 1-butanol (HSP value=23.2) so that an alkali concentration in a separation liquid to be obtained became 10 wt %. Thus, a separation liquid (3) was obtained.

### (Preparation of Separation Liquid (4))

Potassium hydroxide (KOH) was added to 2-propanol (IPA) (HSP value=23.6) so that an alkali concentration in a separation liquid to be obtained became 5 wt %. Thus, a separation liquid (4) was obtained.

### (Preparation of Separation Liquid (5))

Potassium hydroxide (KOH) was added to ethanol (HSP value=26.5) so that an alkali concentration in a separation liquid to be obtained became 5 wt %. Thus, a separation liquid (5) was obtained.

### (Preparation of Separation Liquid (6))

Potassium hydroxide (KOH) was added to a mixed liquid (HSP value=29.5) containing 1-butanol, methanol, and water at 1-butanol:methanol:water=40:40:20 (weight ratio) so that an alkali concentration in a separation liquid to be obtained became 5 wt %. Thus, a separation liquid (6) was obtained

### [Production Example 3]: Preparation of Cover Material

As the cover material, the following ones were prepared.
(1) metal cover (SUS304BA sheet, thickness of 0.5 mm)
(2) PET cover (manufactured by Mitsubishi Chemical Corporation, Product name “DIAFOIL”, thickness of 38 μm)
(3) acrylic cover (manufactured by Mitsubishi Chemical Corporation, Product name “ACRYLITE”, thickness of 1 mm)
(4) silicone cover (PTFE sheet, thickness of 80 μm)

### Example 1

An acrylic pressure-sensitive adhesive tape “RP207” was cut into a size of 20 mm×40 mm, and a separator arranged on a pressure-sensitive adhesion surface of a pressure-sensitive adhesive layer was peeled and removed, and the obtained separator-less pressure-sensitive adhesive tape was used as a test piece. By using a pipetman manufactured by Gilson, 300 g/m² of the separation liquid (1) was applied to the surface of the pressure-sensitive adhesive layer. Subsequently, heating was performed from the side opposite to the surface to which the separation liquid was applied, by a hot plate heated to 60° C., for one minute to perform aging. Subsequently, the surface to which the separation liquid was applied was pressed against sponge wet with ion exchanged water, and was made wet. A coated amount was 70 g/m². Thereafter, the obtained product was left as it was at room temperature for 30 seconds. Thereafter, the pressure-sensitive adhesive layer was rubbed with a fingertip, and whether or not the pressure-sensitive adhesive was separated was confirmed. Subsequently, whether or not the separation liquid deteriorated (for example, became clouded) was visually confirmed.

Evaluation as to whether or not the pressure-sensitive adhesive was separated was made based on the following criteria.
∘: The pressure-sensitive adhesive was separated from the base material in the test piece.
x: The pressure-sensitive adhesive was not separated from the base material in the test piece.

Evaluation as to whether or not the separation liquid deteriorated was made based on the following criteria.
∘: The separation liquid did not become clouded as compared with an initial state.
x: The separation liquid became clouded as compared with an initial state.

Table 1 indicates the results.

### Example 2

An acrylic pressure-sensitive adhesive tape “RP207” was cut into a size of 20 mm×40 mm, and a separator arranged on a pressure-sensitive adhesion surface of a pressure-sensitive adhesive layer was peeled and removed, and the obtained separator-less pressure-sensitive adhesive tape was used as a test piece. The surface of the pressure-sensitive adhesive layer was pressed against sponge wet with the separation liquid (1), and the surface of the pressure-sensitive adhesive layer was made wet. A coated amount was 70 g/m². Subsequently, the coated surface was covered with a metal cover, and heated by a hot plate heated to 60° C. for one minute to perform aging. Subsequently, the surface to which the separation liquid was applied was pressed against sponge wet with ion exchanged water, and was made wet. A coated amount was 70 g/m². Thereafter, the obtained product was left as it was at room temperature for 30 seconds. Thereafter, the pressure-sensitive adhesive layer was rubbed with a fingertip, and whether or not the pressure-sensitive adhesive was separated was confirmed similarly to Example 1. Subsequently, similarly to Example 1, whether or not the separation liquid deteriorated (for example, became clouded) was visually confirmed.

Table 1 indicates the results.

### Comparative Example 1

An acrylic pressure-sensitive adhesive tape “RP207” was cut into a size of 20 mm×40 mm, and a separator arranged on a pressure-sensitive adhesion surface of a pressure-sensitive adhesive layer was peeled and removed, and the obtained separator-less pressure-sensitive adhesive tape was used as a test piece. The test piece was impregnated with 30 g of the separation liquid (1) heated to 60° ° C. in a water bath for one minute, to perform aging. Subsequently, the test piece was taken out, and the test piece was then impregnated with 30 g of ion exchanged water set at room temperature for 30 seconds. Thereafter, the test piece was taken out, and the pressure-sensitive adhesive layer was rubbed with a fingertip, and whether or not the pressure-sensitive adhesive was separated was confirmed similarly to Example 1. Subsequently, similarly to Example 1, whether or not the separation liquid deteriorated (for example, became clouded) was visually confirmed.

Table 1 indicates the results.

TABLE 1

| | | | | Comparative |
|---|---|---|---|---|
| | | Example 1 | Example 2 | example 1 |
| Pressure-sensitive adhesive tape | | RP207 | RP207 | RP207 |
| Separation | Kind | (1) | (1) | (1) |
| liquid | Coated amount (g/m²) | 300 | 70 | dipping |
| Cover | | none | SUS304 | — |
| Aging | Temperature (° C.) | 60 | 60 | 60 |
| condition | Time (minute) | 1 | 1 | 1 |

| | | | |
|---|---|---|---|
| Separation of pressure-sensitive | ∘ | ∘ | ∘ |
| adhesive | | | |
| Deterioration of separation liquid | ∘ | ∘ | x |

### Example 3

An acrylic pressure-sensitive adhesive tape “RP207” was cut into a size of 20 mm×40 mm, and a separator arranged on a pressure-sensitive adhesion surface of a pressure-sensitive adhesive layer was peeled and removed, and the obtained separator-less pressure-sensitive adhesive tape was used as a test piece. The surface of the pressure-sensitive adhesive layer was pressed against sponge wet with the separation liquid (1), and the surface of the pressure-sensitive adhesive layer was made wet. A coated amount was 70 g/m². Subsequently, the coated surface was covered with a metal cover, and heated at room temperature for t minutes to perform aging. Thereafter, the pressure-sensitive adhesive layer was rubbed with a fingertip, and whether or not the pressure-sensitive adhesive was separated was confirmed.

Evaluation was made based on the following criteria. Table 2 indicates the result.
⊚: The pressure-sensitive adhesive was separated from the base material in the test piece at t≤1 (that is, when the test piece was left as it was for one minute or shorter)
∘: The pressure-sensitive adhesive was separated from the base material in the test piece at 1<t≤10 (that is, when the test piece was left as it was for a time which was longer than one minute and not longer than 10 minutes).
Δ: The pressure-sensitive adhesive was separated from the base material in the test piece at 10<t≤60 (that is, when the test piece was left as it was for a time which was longer than 10 minutes and not longer than 60 minutes).
x: The pressure-sensitive adhesive was not separated from the base material in the test piece even at 60<t (that is, when the test piece was left as it was for a time longer than 60 minutes).

### Example 4

Example 4 was the same as Example 3 except that the coated surface was covered with a metal cover, and heated by a hot plate heated to 40° ° C. for t minutes to perform aging.

Table 2 indicates the result.

### Example 5

Example 5 was the same as Example 3 except that the coated surface was covered with a metal cover, and heated by a hot plate heated to 80° C. for t minutes to perform aging.

Table 2 indicates the result.

### Example 6

Example 6 was the same as Example 3 except that an acrylic pressure-sensitive adhesive tape “RP108” was cut into a size of 20 mm×40 mm, a separator arranged on a pressure-sensitive adhesion surface of a pressure-sensitive adhesive layer was peeled and removed, and the obtained separator-less pressure-sensitive adhesive tape was used as a test piece.

Table 2 indicates the result.

### Example 7

Example 7 was the same as Example 3 except that an acrylic pressure-sensitive adhesive tape “No. 3195MS” was cut into a size of 20 mm×40 mm, a separator arranged on a pressure-sensitive adhesion surface of a pressure-sensitive adhesive layer was peeled and removed, and the obtained separator-less pressure-sensitive adhesive tape was used as a test piece.

Table 2 indicates the result.

### Example 8

Example 8 was the same as Example 3 except that a silicone-based pressure-sensitive adhesive tape “No. 360UL” was cut into a size of 20 mm×40 mm and used as a test piece.

Table 2 indicates the result.

### Example 9

Example 9 was the same as Example 3 except that a rubber-based laminated sheet “No. 3040” was cut into a size of 20 mm×40 mm and used as a test piece. Table 2 indicates the result.

### Example 10

Example 10 was the same as Example 3 except that the separation liquid (2) was used instead of the separation liquid (1).

Table 2 indicates the result.

### Example 11

Example 11 was the same as Example 3 except that the separation liquid (3) was used instead of the separation liquid (1).

Table 2 indicates the result.

### Example 12

Example 12 was the same as Example 3 except that the separation liquid (4) was used instead of the separation liquid (1).

Table 2 indicates the result.

### Example 13

Example 13 was the same as Example 3 except that the separation liquid (5) was used instead of the separation liquid (1).

Table 2 indicates the result.

### Example 14

Example 14 was the same as Example 3 except that the separation liquid (6) was used instead of the separation liquid (1).

Table 2 indicates the result.

### Example 15

Example 15 was the same as Example 3 except that the coated surface was covered with a PET cover.

Table 2 indicates the result.

### Example 16

Example 16 was the same as Example 3 except that the coated surface was covered with an acrylic cover.

Table 2 indicates the result.

### Example 17

Example 17 was the same as Example 3 except that the coated surface was covered with a silicone cover.

Table 2 indicates the result.

TABLE 2

| | | Example 3 | Example 4 | Example 5 | Example 6 | Example 7 |
|---|---|---|---|---|---|---|
| Pressure-sensitive | | RP207 | RP207 | RP207 | RP108 | No. 3195MS |
| adhesive tape | | | | | | |
| Separation | Kind | (1) | (1) | (1) | (1) | (1) |
| liquid | Coated amount | 70 | 70 | 70 | 70 | 70 |
| | (g/m²) | | | | | |
| Cover | | SUS304 | SUS304 | SUS304 | SUS304 | SUS304 |
| Aging | Temperature | room | 40 | 80 | room | room |
| | (° C.) | temperature | | | temperature | temperature |

| | | | | | |
|---|---|---|---|---|---|
| Separation of | ◯ | ◯ | ⊚ | ◯ | ◯ |
| pressure-sensitive | | | | | |
| adhesive | | | | | |

| | | Example 8 | Example 9 | Example 10 | Example 11 | Example 12 |
|---|---|---|---|---|---|---|
| Pressure-sensitive | | No. 360UL | No. 3040 | RP207 | RP207 | RP207 |
| adhesive tape | | | | | | |
| Separation | Kind | (1) | (1) | (2) | (3) | (4) |
| liquid | Coated amount | 70 | 70 | 70 | 70 | 70 |
| | (g/m²) | | | | | |
| Cover | | SUS304 | SUS304 | SUS304 | SUS304 | SUS304 |
| Aging | Temperature | room | room | room | room | room |
| | (° C.) | temperature | temperature | temperature | temperature | temperature |
| Separation of | | ◯ | Δ | ◯ | ◯ | ◯ |
| pressure-sensitive | | | | | | |
| adhesive | | | | | | |
| | | Example 13 | Example 14 | Example 15 | Example 16 | Example 17 |
| Pressure-sensitive | | RP207 | RP207 | RP207 | RP207 | RP207 |
| adhesive tape | | | | | | |
| Separation | Kind | (5) | (6) | (1) | (1) | (1) |
| liquid | Coated amount | 70 | 70 | 70 | 70 | 70 |
| | (g/m²) | | | | | |
| Cover | | SUS304 | SUS304 | PET | acryl | silicone |
| Aging | Temperature | room | room | room | room | room |
| | (° C.) | temperature | temperature | temperature | temperature | temperature |

| | | | | | |
|---|---|---|---|---|---|
| Separation of | ◯ | ⊚ | ◯ | ◯ | ◯ |
| pressure-sensitive | | | | | |
| adhesive | | | | | |

### Example 18

A release film (manufactured by Toray Industries, Inc., Product name: CERAPEEL (silicone-based), thickness of 38 μm) was cut into a size of 20 mm×40 mm, and used as a test piece. The surface, which was a silicone-treated surface, was pressed against sponge wet with the separation liquid (1), and was made wet. A coated amount was 70 g/m². Subsequently, the coated surface was covered with a metal cover and heated at room temperature for one minute to perform aging. Thereafter, the silicone-treated surface was rubbed with a spatula, and whether or not the silicone-treated surface was separated was confirmed by IR.

Evaluation was made based on the following criteria.
∘: A silicone-derived peak at 2950 cm⁻¹ disappeared.
x: A silicone-derived peak at 2950 cm⁻¹ appeared.

Table 3 indicates the result.

### Example 19

A backside surface-treated film (manufactured by Nitto Denko Corporation, urethane-treated PET) was cut into a size of 20 mm×40 mm, and used as a test piece. The surface, which was the urethane treated surface, was pressed against sponge wet with the separation liquid (1), and was made wet. A coated amount was 70 g/m². Subsequently, the coated surface was covered with a metal cover, and heated at room temperature for one minute to perform aging. Thereafter, the urethane-treated surface was rubbed with a spatula, and whether or not the urethane-treated layer was separated was confirmed by IR.

Evaluation was made based on the following criteria.
∘: A urethane-derived peak at 1550 cm⁻¹ disappeared.
x: A urethane-derived peak at 1550 cm⁻¹ appeared.

Table 3 indicates the result.

TABLE 3

| | | Example 18 | Example 19 |
|---|---|---|---|
| Laminated sheet | | release film | backside surface- |
| | | | treated film |
| Separation | Kind | (1) | (1) |
| liquid | Coated amount (g/m²) | 70 | 70 |
| Cover | | SUS304 | SUS304 |
| Aging | Temperature (° C.) | 60° C. | 60° C. |
| condition | Time (minute) | 1 | 1 |

| | | |
|---|---|---|
| Separation of functional layer | ∘ | ∘ |

### INDUSTRIAL APPLICABILITY

The laminated sheet processing method according to the embodiment of the present invention allows the base material and the functional layer for forming many kinds of laminated sheets, such as pressure-sensitive adhesive tapes, release films, and antistatic films, to be easily separated from each other at low cost, and can thus be suitably used for, for example, recycling laminated sheet waste produced in a large amount in production sites or the like.

### DESCRIPTION OF THE REFERENCE CHARACTERS

1000 separation liquid
2000 aqueous liquid
3000 separation device
3001 separation device
3002 separation device
100 laminated sheet
100′ laminated sheet
101 laminated sheet
101′ laminated sheet
102 laminated sheet
102′ laminated sheet
200 laminate
10 base material layer
11 base material layer
12 base material layer
20 functional layer
21 functional layer
22 functional layer
20′ component derived from functional layer
21′ component derived from functional layer
22 component derived from functional layer
30 separator
31 separator
32 separator
1 roll body
2 separator winding roll
3 roll body
4 roll
5 roll body
6 roll body
7 separator winding roll
8 seperator winding roll
9 roll
10 roll

1. A laminated sheet processing method for processing a laminated sheet including a base material layer and a functional layer, the laminated sheet processing method comprising
a step (I) of applying a separation liquid to a surface of the functional layer.

2. The laminated sheet processing method according to claim 1, comprising a step (II) of covering a coated surface to which the separation liquid has been applied in the step (I), with a cover material.

3. The laminated sheet processing method according to claim 2, wherein the cover material is a backside surface, on an opposite side, of the functional layer as viewed from the base material layer of the laminated sheet.

4. The laminated sheet processing method according to claim 2, wherein the cover material is the functional layer.

5. The laminated sheet processing method according to claim 2, comprising a step (III) of applying an aqueous liquid to the coated surface to which the separation liquid has been applied in the step (I), or impregnating the coated surface with an aqueous liquid.

6. The laminated sheet processing method according to claim 5, comprising a step (IV) of separating a component derived from the functional layer, from the base material layer.

7. The laminated sheet processing method according to claim 1, wherein
the separation liquid contains a liquid having a Hansen solubility parameter value of 31 or less, and an alkaline compound, and
a concentration of the alkaline compound in the separation liquid is from 0.001 wt % to 10 wt %.

8. The laminated sheet processing method according to claim 1, wherein the functional layer is formed of at least one kind selected from the group consisting of an acrylic pressure-sensitive adhesive, a urethane-based pressure-sensitive adhesive, a rubber-based pressure-sensitive adhesive, a silicone-based pressure-sensitive adhesive, a release layer, and an antistatic layer.

9. A laminated sheet processing device comprising:
feeding means for feeding a laminated sheet including a base material layer and a functional layer;
transporting means for transporting the laminated sheet;
separation liquid application means for applying a separation liquid to a surface of the functional layer;
separation means for separating a component derived from the functional layer, from the base material layer; and
recovering means for recovering a layer that remains after the component derived from the functional layer is separated from the base material layer.

10. The laminated sheet processing device according to claim 9, comprising aqueous liquid application means for applying an aqueous liquid to a coated surface to which the separation liquid has been applied.

11. The laminated sheet processing device according to claim 9, comprising aging means.
